(19) United States
(12) Patent Application Publication
(10) Pub. No.: US 2014/0115832 A1
(43) Pub. Date: May 1, 2014

(54) Systems and Methods For Providing A Safety Cord For Window Covering Systems

(71) Applicant: Steven J. Levin, St. Louis, MO (US)

(72) Inventor: Steven J. Levin, St. Louis, MO (US)

(21) Appl. No.: 14/149,848

(22) Filed: Jan. 8, 2014

Related U.S. Application Data
(62) Division of application No. 12/916,842, filed on Nov. 1, 2010.
Application No. 12/916,842 is a continuation-in-part of application No. 12/615,574, filed on Nov. 10, 2009, now abandoned.

(51) Int. Cl. F16G 11/10

(52) U.S. Cl. CPC F16G 11/10
USPC 24/115 F

(57) ABSTRACT

In various embodiments, a lift cord safety coupling is provided. In such embodiments, the lift cord safety coupling includes a first connector having a lift cord aperture structured to have a lift cord of a shade extended therethrough, and a second connector connectable to an intermediate portion of the shade and magnetically connectable to the first connector. The first and second connectors are magnetically connectable with an amount of attractive force such that when a longitudinal and/or lateral force below a predetermined threshold force is applied to either of the first or second connectors, the first and second connectors will remain connected. However, when a longitudinal and/or lateral force greater than or equal to the predetermined threshold force is applied to either of the first or second connectors, the first and second connectors will decouple disconnecting the lift cord from the shade intermediate portion.

### CROSS-REFERENCE TO RELATED APPLICATIONS

This application is a divisional of U.S. patent application Ser. No. 12/916,842 filed on Nov. 1, 2010, which is a continuation-in-part of U.S. patent application Ser. No. 12/615,574 filed on Nov. 10, 2009. The disclosures of which are incorporated herein by reference.

### FIELD

The present teachings relate to window covering systems that include a safety clutch cord and, in various embodiments, safety lift cords.

### BACKGROUND

The statements in this section merely provide background information related to the present disclosure and may not constitute prior art.

Many window covering systems, such as various types of roller shade systems, horizontal pleated shade systems, vertical pleated shade systems, horizontal louvered blind systems, vertical louvered blind systems, drape or curtain systems, etc., utilize a closed, or continuous, loop clutch cord, and in some instances, a plurality of lift cords to operate the respective system. More particularly, longitudinal movement of the closed, or continuous, loop clutch cord, i.e., pulling on any portion of the clutch cord, rotates a drive wheel of the respective clutch mechanism, which in turn operates the clutch mechanism to move, or transition, a window covering of the window covering system, e.g., one or more shades or sets blinds, to any desired open or closed position. Additionally, if the respective window covering system includes a plurality of lift cords, the lift cords are typically connected at an upper end to a portion of a head unit of the widow covering system, and connected at a lower end to a bottom portion of the respective shade, thereby creating a closed, or continuous, circuit with the shade.

Such closed, or continuous, loop clutch cords and lift cords present various hazards, dangers, and risks because of the closed, or continuous, loop nature of the cords.

### SUMMARY

Generally, the present disclosure provides systems and methods for providing a safety lift cord assembly for window covering systems.

In various embodiments, the present disclosure provides a safety coupling for a lift cord of a window covering system. In such embodiments, the safety coupling includes a first connector including a lift cord aperture structured to have a lift cord of a shade extended therethrough. An upper end of the lift cord is connectable to a shade movement barrel of the window covering system and a lower end of the lift cord is connectable to a bottom portion of a shade of the window covering system. Thus, the shade movement barrel is operatively connected to the shade bottom portion such that operation of the shade movement barrel will apply a longitudinal force to the lift cord that will move at least a portion of the shade between a first position and a second position. The safety coupling additionally includes a second connector that is connectable to an intermediate portion of the shade and magnetically connectable to the first connector to slidingly connect the lift cord to the shade intermediate portion and restrict lateral movement of the lift cord during movement of the at least a portion of the shade between the first position and the second position. Particularly, the first and second connectors magnetically connectable with an amount of attractive force such that when a longitudinal and/or lateral force below a predetermined threshold force is applied to either of the first or second connectors, the first and second connectors will remain connected. Thus, the lift cord will remain slidingly connected to the shade intermediate portion and lateral movement of the lift cord will be restricted as the at least a portion of the shade is moved between the first position and the second position. However, when a longitudinal and/or lateral force greater than or equal to the predetermined threshold force is applied to either of the first or second connectors, the first and second connectors will decouple disconnecting the lift cord from the shade intermediate portion.

In various other embodiments, the present disclosure provides a safety lift cord assembly for a window covering system. In such embodiments, the safety lift cord assembly includes a lift cord having an upper end connectable to a shade movement barrel of the window covering system and a lower end connectable to a bottom portion of a shade of the window covering system. Thus, the shade movement barrel is operatively connected to the shade bottom portion such that operation of the shade movement barrel will apply a longitudinal force to the lift cord that will move at least a portion of the shade between a first position and a second position. Additionally, the safety lift cord assembly includes at least one lift cord intermediate safety coupling structured and operable to slidingly connect the lift cord to an intermediate portion of the shade and to restrict lateral movement of the lift cord during movement of the at least a portion of the shade between the first position and the second position.

Each lift cord intermediate safety coupling includes a first connector including a lift cord aperture structured to have a lift cord of a shade extended therethrough and a second connector connectable to the intermediate portion of the shade and magnetically connectable to the first connector. When the first and second connectors are magnetically coupled, each intermediate safety coupling slidingly connects the respective lift cord to the respective shade intermediate portion and restricts lateral movement of the lift cord during movement of the shade between the first position and the second position. Particularly, the first and second connectors magnetically connectable with an amount of attractive force such that when a longitudinal and/or lateral force below a predetermined threshold force is applied to either of the first or second connectors, the first and second connectors will remain connected. Thus, the lift cord will remain slidingly connected to the shade intermediate portion and lateral movement of the lift cord will be restricted as the at least a portion of the shade is moved between the first position and the second position. However, when a longitudinal and/or lateral force greater than or equal to the predetermined threshold force is applied to either of the first or second connectors, the first and second connectors will decouple disconnecting the lift cord from the shade intermediate portion.

In yet other embodiments, the present disclosure provides a safety lift cord assembly for a window covering system. In such embodiments, the window covering system includes a head unit mountable to structure forming a window opening. The head unit includes a clutch mechanism connected to an end of a shade movement barrel such that operation of the clutch mechanism operates the shade movement barrel. The window covering system additionally includes a shade having a top portion connected to the head unit, and a plurality of safety lift cord assemblies structured to operatively connect a bottom portion of the shade to the shade movement barrel to move at least a portion of the shade between a first position and a second position when the clutch mechanism is operated. Each safety lift cord assembly includes a lift cord having an upper end connectable to the shade movement barrel and a lower end connectable to the shade bottom portion. Thus, the shade movement barrel is operatively connected to the shade bottom portion such that operation of the shade movement barrel will apply a longitudinal force to the lift cord that will move at least a portion of the shade between a first position and a second position. Additionally, each safety lift cord assembly includes a plurality of lift cord intermediate safety couplings structured and operable to slidingly connect the lift cord to a plurality of intermediate portions of the shade and to restrict lateral movement of the lift cord during movement of the at least a portion of the shade between the first position and the second position.

Each lift cord intermediate safety coupling includes a first connector including a lift cord aperture structured to have a lift cord of a shade extended therethrough and a second connector connectable to the intermediate portion of the shade and magnetically connectable to the first connector. When the first and second connectors are magnetically coupled, each intermediate safety coupling slidingly connects the respective lift cord to the respective shade intermediate portion and restricts lateral movement of the lift cord during movement of the shade between the first position and the second position. Particularly, the first and second connectors magnetically connectable with an amount of attractive force such that when a longitudinal and/or lateral force below a predetermined threshold force is applied to either of the first or second connectors, the first and second connectors will remain connected. Thus, the lift cord will remain slidingly connected to the shade intermediate portion and lateral movement of the lift cord will be restricted as the at least a portion of the shade is moved between the first position and the second position. However, when a longitudinal and/or lateral force greater than or equal to the predetermined threshold force is applied to either of the first or second connectors, the first and second connectors will decouple disconnecting the lift cord from the shade intermediate portion.

In still yet other embodiments, the present disclosure provides a method for providing a safety lift cord assembly for a window covering system. In such embodiments the method includes extending a lift cord of the window covering system through a lift cord aperture formed in a proximal end of a first connector of each of a plurality of intermediate safety couplings. Each intermediate safety coupling first connector includes a first magnet disposed at a distal end. The method additionally includes connecting a second connector of each intermediate safety coupling to a respective intermediate portion of a shade of the window covering system. Each intermediate safety coupling second connector includes a body connectable to the respective shade intermediate portion at a proximal end and has a second magnet disposed at a distal end. Thus, intermediate safety coupling second connector is magnetically connectable to the intermediate safety coupling first connector to slidingly connect the lift cord to the respective shade intermediate portions and restrict lateral movement of the lift cord during movement of at least a portion of the shade between a first position and a second position.

Each lift cord intermediate safety coupling includes a first connector including a lift cord aperture structured to have a lift cord of a shade extended therethrough and a second connector connectable to the intermediate portion of the shade and magnetically connectable to the first connector. When the first and second connectors are magnetically coupled, each intermediate safety coupling slidingly connects the respective lift cord to the respective shade intermediate portion and restricts lateral movement of the lift cord during movement of the shade between the first position and the second position. Particularly, the first and second connectors magnetically connectable with an amount of attractive force such that when a longitudinal and/or lateral force below a predetermined threshold force is applied to either of the first or second connectors, the first and second connectors will remain connected. Thus, the lift cord will remain slidingly connected to the shade intermediate portion and lateral movement of the lift cord will be restricted as the at least a portion of the shade is moved between the first position and the second position. However, when a longitudinal and/or lateral force greater than or equal to the predetermined threshold force is applied to either of the first or second connectors, the first and second connectors will decouple disconnecting the lift cord from the shade intermediate portion.

The method further includes magnetically connecting each respective intermediate safety coupling first and second connectors to slidingly connect the lift cord to the respective shade intermediate portions and restrict lateral movement of the lift cord during movement of at least a portion of the shade between a first position and a second position.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a schematic of a portion of an exemplary window covering system, in accordance with various embodiments of the present disclosure.

FIG. 2A is schematic of the window covering system shown in FIG. 1, illustrating a safety clutch cord of the window covering system in a coupled configuration, in accordance with various embodiments of the present disclosure.

FIG. 2B is schematic of the window covering system shown in FIG. 1, illustrating the safety clutch cord of the window covering system in a decoupled configuration, in accordance with various embodiments of the present disclosure.

FIG. 3A is schematic of a portion of the safety clutch cord of the window covering system shown in FIG. 1, illustrating a safety coupling of the window covering system, in accordance with various embodiments of the present disclosure.

FIG. 3B is an exploded view of safety coupling shown in FIG. 3A, in accordance with various embodiments of the present disclosure.

FIG. 4A is schematic of a portion of the safety clutch cord of the window covering system shown in FIG. 1, illustrating a safety coupling of the window covering system, in accordance with various other embodiments of the present disclosure.

FIG. 4B is schematic of a portion of the safety clutch cord of the window covering system shown in FIG. 1, illustrating an exploded view of a safety coupling of the window covering system, in accordance with yet other embodiments of the present disclosure.

FIG. 5 is schematic of a portion of the safety clutch cord of the window covering system shown in FIG. 1, illustrating a safety clutch cord holding button of the window covering system, in accordance with various other embodiments of the present disclosure.

FIG. 6 is a schematic of the window covering system shown in FIG. 1 including a plurality of safety lift cord assemblies, in accordance with various embodiments of the present disclosure.

FIG. 7 is a schematic of a portion of the safety lift cord assembly shown in FIG. 6, illustrating a safety lift cord bottom safety coupling in a coupled configuration, in accordance with various embodiments of the present disclosure.

FIG. 8 is a schematic of a portion of the safety lift cord assembly shown in FIG. 6, illustrating the safety lift cord bottom safety coupling in a decoupled configuration, in accordance with various embodiments of the present disclosure.

FIG. 9A is schematic of a portion of the safety lift cord assembly shown in FIG. 6, illustrating the components of the safety lift cord bottom safety coupling, in accordance with various embodiments of the present disclosure.

FIG. 9B is an exploded view of safety lift cord bottom safety coupling shown in FIG. 8A, in accordance with various embodiments of the present disclosure.

FIG. 10A is a top view of a guide ring of the safety lift cord assembly shown in FIG. 6, in accordance with various embodiments of the present disclosure.

FIG. 10B is a side view of the guide ring shown in FIG. 10A, in accordance with various embodiments of the present disclosure.

FIG. 11A is a schematic of a portion of the safety lift cord assembly shown in FIG. 6, illustrating a removably connectable bottom safety coupling, in accordance with various embodiments of the present disclosure.

FIG. 11B is schematic of the safety lift cord bottom safety coupling shown in FIG. 11A, in accordance with various embodiments of the present disclosure.

FIG. 11C is an exploded view of the bottom safety coupling shown in FIG. 11A, in accordance with various embodiments of the present disclosure.

FIG. 11D is an illustration of an exemplary removably connectable fastening device for a second connector of the bottom safety coupling shown in FIG. 11A, in accordance with various embodiments of the present disclosure.

FIG. 11E is an illustration of another exemplary removably connectable fastening device for a second connector of the bottom safety coupling shown in FIG. 11A, in accordance with various other embodiments of the present disclosure.

FIG. 12A is a schematic of the safety lift cord assemblies shown in FIG. 6, illustrating a plurality of safety lift cord intermediate safety couplings, in accordance with various embodiments of the present disclosure.

FIG. 12B is schematic of one of the safety lift cord intermediate safety couplings shown in FIG. 13A, in accordance with various embodiments of the present disclosure.

FIG. 12C is an exploded view of the safety lift cord intermediate safety coupling shown in FIG. 12B, in accordance with various embodiments of the present disclosure.

FIG. 13A is a schematic of the safety lift cord assembly shown in FIG. 6, illustrating a plurality of removably connectable intermediate safety couplings, in accordance with various embodiments of the present disclosure.

FIG. 13B is schematic of one of the safety lift cord intermediate safety couplings shown in FIG. 13A, in accordance with various embodiments of the present disclosure.

FIG. 13C is an exploded view of the intermediate safety coupling shown in FIG. 13B, in accordance with various embodiments of the present disclosure.

FIG. 13D is an illustration of an exemplary removably connectable fastening device for a second connector of the intermediate safety coupling shown in FIG. 13B, in accordance with various embodiments of the present disclosure.

FIG. 13E is an illustration of another exemplary removably connectable fastening device for a second connector of the intermediate safety coupling shown in FIG. 13B, in accordance with various other embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

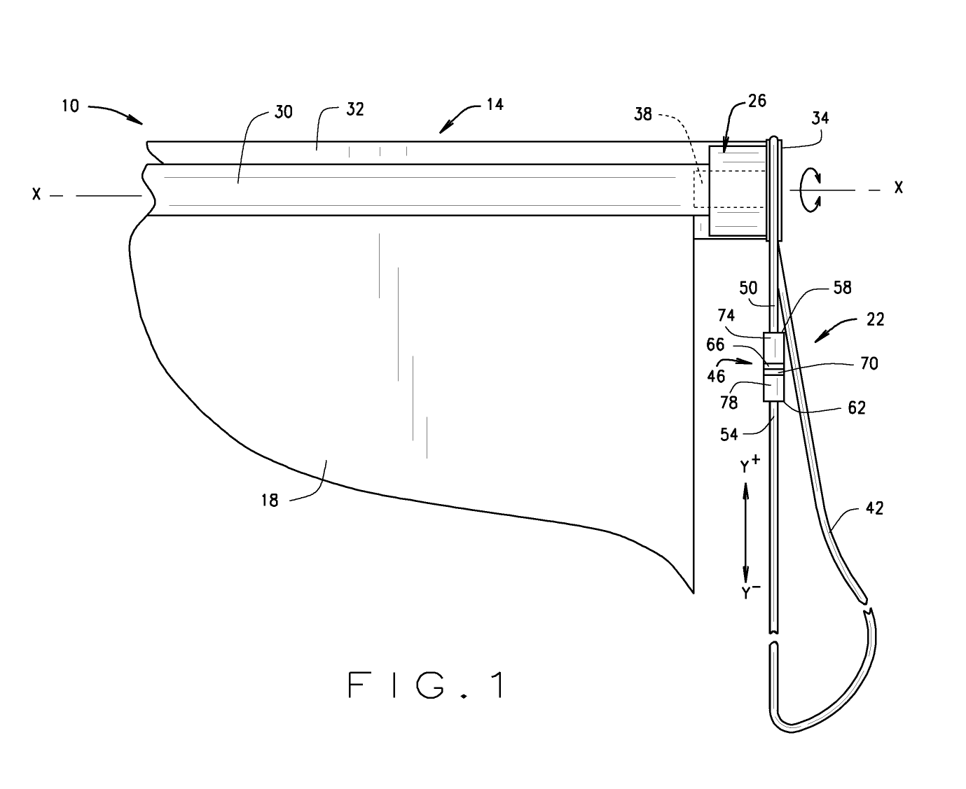

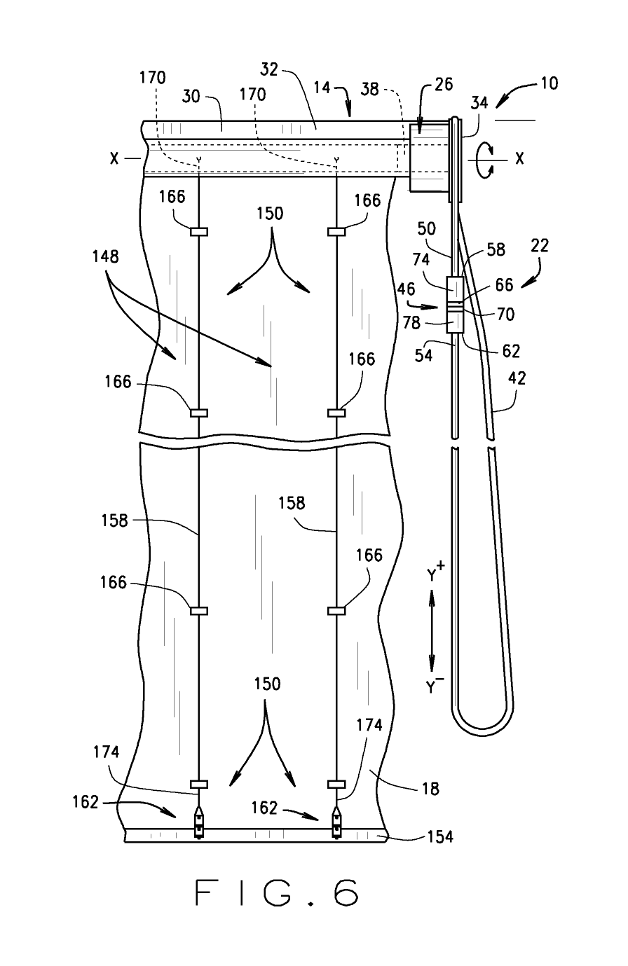

FIG. 1 illustrates a portion of a window covering system 10, in accordance with various embodiments of the present disclosure. Generally, the window covering system 10 includes a head unit 14, a window covering 18 and a safety clutch cord 22. In various implementations, the head unit 14 is mountable to or within a window opening (not shown). That is, the head unit 14 can be mounted to the structure 24 (shown in FIG. 5) forming a window opening, e.g., the window framework and/or wall covering, using any suitable mounting means, e.g., screwing, gluing, nailing, riveting, etc.

Generally, the head unit 14 includes a clutch mechanism 26 and a window covering movement mechanism 30 connected to the clutch mechanism 26. In various embodiments, the head unit 14 can include a housing 32 that encloses the window covering movement mechanism 30 and at least a portion of the clutch mechanism 26. A portion of the head unit housing 32 has been removed in FIG. 1 to more clearly illustrate the clutch mechanism 26 and the window covering movement mechanism 30.

The window covering 18 is connected to the window covering movement mechanism 30 such that operation of the window covering movement mechanism 30 will cause at least a portion of the window covering to move, or transition, from one position to another. More specifically, the clutch mechanism 26 includes a drive wheel 34 and drive spindle 38 to which the window covering movement mechanism 30 is connectable. The drive spindle 38 is fixedly coupled to the drive wheel 34 and orthogonally extending from an inner face of the drive wheel 34. The window covering movement mechanism 30 can be fixedly or removably connected to, on or over the drive spindle 38 in any manner suitable to engage the window covering movement mechanism 30 with the drive spindle 38. Particularly, the window covering movement mechanism 30 is engaged with the drive spindle 38 such that rotation of the drive wheel 34 about an X axis will rotate the drive spindle 38 about the X axis, which will operate the window covering movement mechanism 30 to move at least a portion of the window covering 18, as described below.

The window covering 18 is connected to the window covering movement mechanism 30 such that operation of the window covering movement mechanism 30 will cause at least a portion of the window covering 18 to move, or transition, between various opened and closed positions. More particularly, rotation of the drive wheel 34 in a first direction, and the resulting rotation of the drive spindle 38, will operate the window covering movement mechanism 30 to cause at least a portion of the window covering 18 to move from a first position, which can be any possible closed position of the respective portion of the window covering 18, to a second position, which can be any other possible opened position of the respective portion of the window covering 18. Similarly, rotation of the drive wheel 34 a second direction that is opposite the first direction, and the resulting rotation for drive spindle 38, will operate the window covering movement mechanism 30 to cause at least a portion of the window covering 18 to move from a first position, which can be any possible opened position of the respective portion of the window covering 18, to a second position, which can be any possible closed position of the respective portion of the window covering 18. Hence, rotation of the drive wheel 34 will operate the window covering movement mechanism 30, thereby causing a least a portion of the window covering 18 to move between any possible opened or closed position of the respective portion of the window covering 18 and any other possible opened or closed position of the respective portion of the window covering 18.

The window covering 18 can be any type of window covering, such as a roller shade, a horizontal pleated shade, a vertical pleated shade, horizontal louvered blinds, vertical louvered blinds, drapes or curtains, etc. Importantly, although FIG. 1 exemplarily illustrates the window covering 18 as a roller shade, it should be understood that the window covering 18 can be any other suitable type of window covering and remain within the scope of the present disclosure. Additionally, the window covering 18 can be connected to the window covering drive mechanism 30 in any manner suitable to impart movement of at least a portion of the respective window covering 18 upon operation of the window covering drive mechanism 30, as described herein. Furthermore, the window covering movement mechanism 30 can be any mechanism, device, apparatus or system structured and operable to impart movement on at least a portion of the window covering 18 when driven, or operated, by the clutch mechanism 26, i.e., the drive spindle 38, as described herein.

For example, in various embodiments, the window covering 18 can be a roller shade and the window covering movement mechanism 30 can be a cylindrical barrel, e.g., a tube or rod, to which a top edge of the roller shade 18 is connected. In such embodiments, the window covering barrel 30 is engaged with the drive spindle 38 such that rotation of the drive wheel 34 rotates the window covering barrel 30, thereby causing the roller shade 18 to wrap around, or unwrap from, the window covering barrel 30, depending on the direction in which the drive wheel 34 is rotated.

Alternatively, in various other exemplary embodiments, the window covering 18 can be a horizontal pleated shade and the window covering movement mechanism 30 can be a cylindrical barrel, e.g., a tube or rod, to which a plurality of retracting cords are connected. The retracting cords are interlaced with the horizontal pleated shade 18 and connected to a bottom portion of the horizontal pleated shade 18. In such embodiments, the window covering barrel 30 is engaged with the drive spindle 38 such that rotation of the drive wheel 34 rotates the window covering barrel 30, thereby causing the retracting cords to wrap around the window covering barrel 30 to raise the horizontal pleated shade 18, or unwrap from the window covering barrel 30 to lower the horizontal pleated shade 18, depending on the direction in which the drive wheel 34 is rotated.

In still other exemplary embodiments, the window covering 18 can be a vertical blinds system and the window covering movement mechanism 30 can be a track and pulley system, e.g., one or more guide tracks along which a plurality of blind carriages are moved via longitudinal movement of at least one carriage cord within the guide track(s). In such embodiments, the vertical blind system 18 includes a plurality of blinds that are connected to the blind carriages such that movement of the blind carriages results in movement of the blinds. Furthermore, in such embodiments, the track and pulley system 30 is engaged with the drive spindle 38 such that rotation of the drive wheel 34 rotates the drive spindle 38, which, in turn, operated the track and pulley system 30 such that blind carriages and blinds are horizontally moved to any desired opened or closed position, depending on the direction in which the drive wheel 34 is rotated.

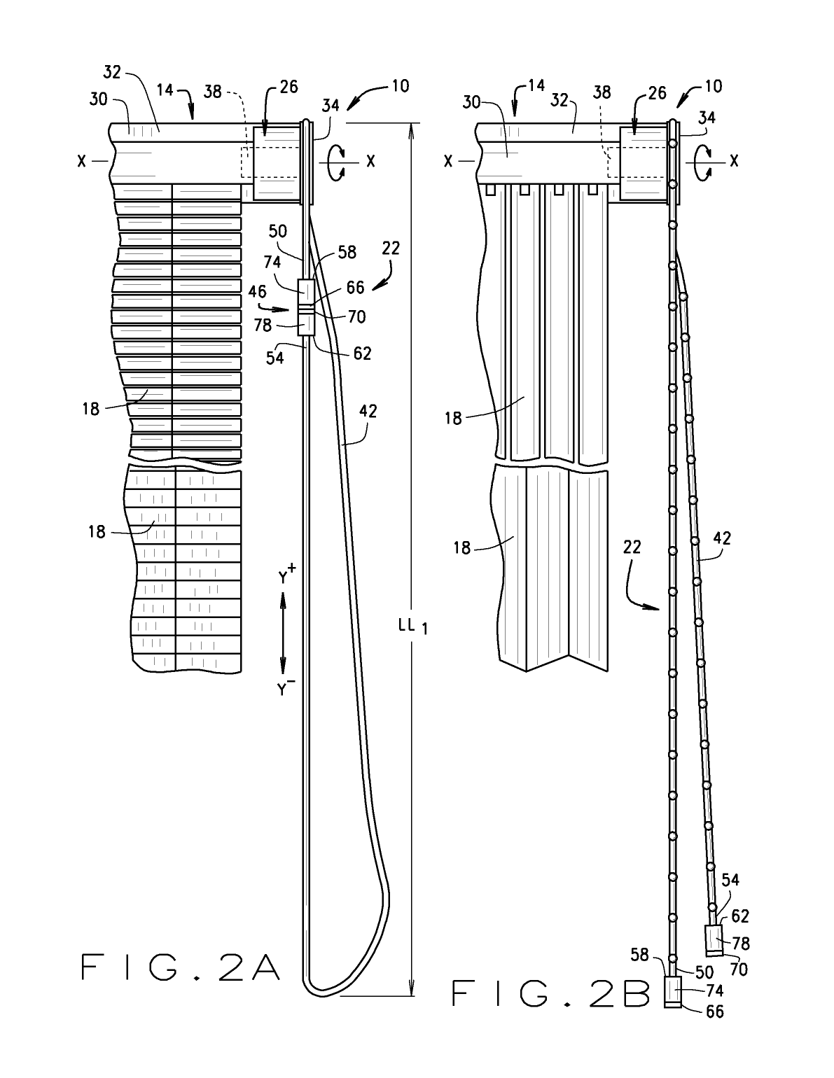

It is envisioned that the window covering system 10, as disclosed herein, can be any window covering system that utilizes a closed, or continuous, loop clutch cord, e.g., the safety clutch cord 22, as described herein. Moreover, in light of the exemplary embodiments described herein, one skilled in the art will readily and clearly understand that the window covering system 10, as described herein, can include any window covering system that utilizes a closed, or continuous, loop clutch cord, e.g., the safety clutch cord 22, such as a roller shade system (exemplarily illustrated in FIG. 1), a horizontal pleated shade system (exemplarily illustrated in the bottom portion of the window covering 18 FIG. 2A), a vertical pleated shade system (exemplarily illustrated in the bottom portion of the window covering 18 FIG. 2B), a horizontal louvered blinds system (exemplarily illustrated in the top portion of the window covering 18 FIG. 2A), a vertical louvered blinds system (exemplarily illustrated in the top portion of the window covering 18 FIG. 2B), drapes or curtain systems (exemplarily illustrated in FIG. 5), a folding shade, e.g., (exemplarily illustrated in FIG. 6), etc.

As used herein, the phrase at least a portion of the window covering is meant to describe any portion of the respective window covering 18 that is moved via operation of the window covering movement mechanism 30 as driven by rotation of the drive wheel 34. For example, rotation of the drive wheel 34, and hence the drive spindle 38, can cause any portion of the respective window covering 18 to move from one position to another position. Or, rotation of the drive wheel 34, and hence the drive spindle 38, can cause the entire respective window covering 18 to move from one position to another position.

With additional reference to FIGS. 2A and 2B, the safety clutch cord 22 includes a clutch cord 42, also referred to as a pull cord or control cord, and a clutch cord safety coupling 46 integrally disposed within the clutch cord 42. The clutch cord 42 is disposed about a drive wheel 34 of the clutch mechanism 26 within a channel formed in the peripheral edge of the drive wheel 34. Particularly, the clutch cord 42 is disposed about the drive wheel 34 such that movement of the safety clutch cord 22 generally in the Y⁺ or Y⁻ direction rotates the drive wheel 34 to operate the clutch mechanism 26 to operate the window covering movement mechanism 30 to move at least a portion of the window covering between the first position and the second position, as described above. The clutch cord 42 can comprise any flexible device, mechanism or apparatus suitable for disposition about drive wheel 34 and suitable to impart forces on the drive wheel 34 sufficient to rotate the drive wheel 34 and drive the window covering movement mechanism 14 when a longitudinal force is applied to any portion of the clutch cord 42, i.e., a force in a direction that is substantially coaxial with the portion of the clutch cord 42 to which the force is being applied. For example, in various embodiments, the clutch cord 42 can comprise a woven fabric or synthetic material rope or cord, e.g., a nylon or cotton rope or cord, or a metal cable or chain, as exemplarily illustrated in FIG. 2A.

Alternatively, in various other embodiments, the clutch cord 42 can comprise a synthetic or plastic beaded rope or cord, as exemplarily illustrated in FIG. 2B. In such embodiments, the channel formed in the peripheral edge of the drive wheel 34 can include semi-spherical recesses spaced along the channel to mate with the beads of the beaded rope or cord, thereby aiding in imparting the forces on the drive wheel 34 sufficient to rotate the drive wheel 34.

The clutch cord safety coupling 46 is structured and operable to detachably connect a first end 50 and second end 54 of the clutch cord 42. More specifically, the clutch cord safety coupling 46 includes a first connector 58 connectable to the first end 50 of the clutch cord 42, and a second connector 62 connectable to the second end 54 of the clutch cord 42. The clutch cord safety coupling 46 additionally includes a first magnet 66 disposed at distal end of a body 74 of the first connector 58, and a second magnet 70 disposed at the distal end of a body 78 of the second connector 62. It should be understood that as used herein, the terms first and second ends 50 and 54 refer to the end portions of the clutch cord 42, e.g., the portions of the clutch cord 42 near the respective terminal ends of the clutch cord 42. The first and second magnets 66 and 70 can be disposed, i.e., mounted, connected, coupled or attached, to the distal ends of the respective connector bodies 74 and 78 in any suitable fashion. For example, the first and second magnets 66 and 70 can be glued, ultrasonically welded, snapped, screwed, friction fitted, etc., into or on the distal ends of the respective connector bodies 74 and 78.

The first and second connectors 58 and 62 can be connected to the respective clutch cord first and second ends 50 and 54 in any manner suitable to fixedly retain the first and second connectors 58 and 62 on the respective clutch cord first and second ends 50 and 54, as described below. Additionally, the first and second magnets 66 and 70 are disposed on the distal ends of the respective first and second connector bodies 74 and 78 such that when placed in close proximity to each other, an attractive magnetic flux field of a predetermined force, or strength, is generated between the first and second magnets 66 and 70. Accordingly, in response to the attractive magnetic flux field, the first and second magnets 66 and 70, and hence, first and second connectors 58 and 62, magnetically connect when brought within close proximity to each other, thereby forming, or structuring, the clutch cord 42 in a closed, or continuous, loop. The closed loop clutch cord 42 is operable, via application of longitudinal force to any portion of the closed loop clutch cord 42, to operate the head unit 14 and clutch mechanism 26 to move at least a portion of the window covering between the first position and the second position, as described above.

More particularly, the first and second magnets 66 and 70 are selected to have a magnetic material structure or composition that will generate a predetermined amount of attractive force when placed in close proximity to each other. That is, the first and second magnets 66 and 70 are selected to have magnetic material structures or compositions that will generate an attractive magnet flux field sufficient to maintain connection of the first and second connectors 58 and 62 until a predetermined amount of longitudinal force is applied to either of the first or second connectors 58 or 62, via application of longitudinal force to any portion of the closed loop clutch cord 42. The predetermined amount of longitudinal force applied to either of the first or second connectors 58 or 62 that will cause the first and second connectors 58 and 62 to decouple, is referred to herein as the predetermined clutch cord threshold force.

Still more specifically, the first and second connectors 58 and 62 are magnetically connectable to each other, via the first and second magnets 66 and 70, with an amount of attractive force such that application of a longitudinal force to the closed loop clutch cord 42 that is below the clutch cord threshold force will operate the clutch mechanism 26 and head unit 14, as described above. However, application of a longitudinal force equal to or greater than the clutch cord threshold force will decouple, i.e., separate or pull apart, the first and second connectors 58 and 62, thereby severing the closed loop safety clutch cord 22.

Still yet more specifically, when a longitudinal force below the predetermined clutch cord threshold force is applied to either of the first or second connectors 66 or 70, via application of a longitudinal force below the predetermined clutch cord threshold force to any portion of the closed loop clutch cord 42, the first and second connectors 58 and 62 will remain connected and the resulting movement of the closed loop clutch cord 42 will function to rotate the drive wheel 34 and operate the head unit clutch mechanism 30 to move at least a portion of the window covering 18 between the first position and the second position. Conversely, when a longitudinal force greater than or equal to the predetermined clutch cord threshold force is applied to either of the first or second connectors 58 or 70, via application of a longitudinal force greater than or equal to the predetermined clutch cord threshold force to any portion of the closed loop clutch cord 42, the first and second connectors 58 and 70 will decouple severing the closed loop safety clutch cord 22.

The clutch cord threshold force is predetermined based on the structure of the respective clutch mechanism 26, head unit 14 and window covering 18 to be a force sufficient to retain the magnetic connection of the respective first and second connectors 58 and 70 while a longitudinal force sufficient to rotate the respective clutch mechanism 26 and operate the respective head unit 14 to move at least a portion of the respective window covering from the first position to the second position is applied to any portion of the closed loop clutch cord 42. But, the predetermined clutch cord threshold force is insufficient to retain the magnetic connection of the respective first and second connectors 58 and 70 when a longitudinal force greater than a force necessary to operate the respective clutch mechanism 26 and head unit 14 to move the respective window covering 18 is applied to any portion of the closed loop clutch cord 42. For example, the predetermined clutch cord threshold force is selected to be sufficient to retain connection of the first and second connectors 58 and 70 during operation of the clutch mechanism 26 and head unit 14, as described above, but, also selected such that if a child were to have their arm, leg, or worse begin to become entangled in the closed loop clutch cord 42 of the safety clutch cord 22 of the present disclosure, the resulting force on the safety clutch cord 22 would be greater than the predetermined clutch cord threshold force such that the first and second connectors 58 and 70 would easily and readily decouple, severing the closed loop clutch cord 42, thereby allowing the child's arm or leg to fall free from the severed clutch cord 42 of the safety clutch cord 22.

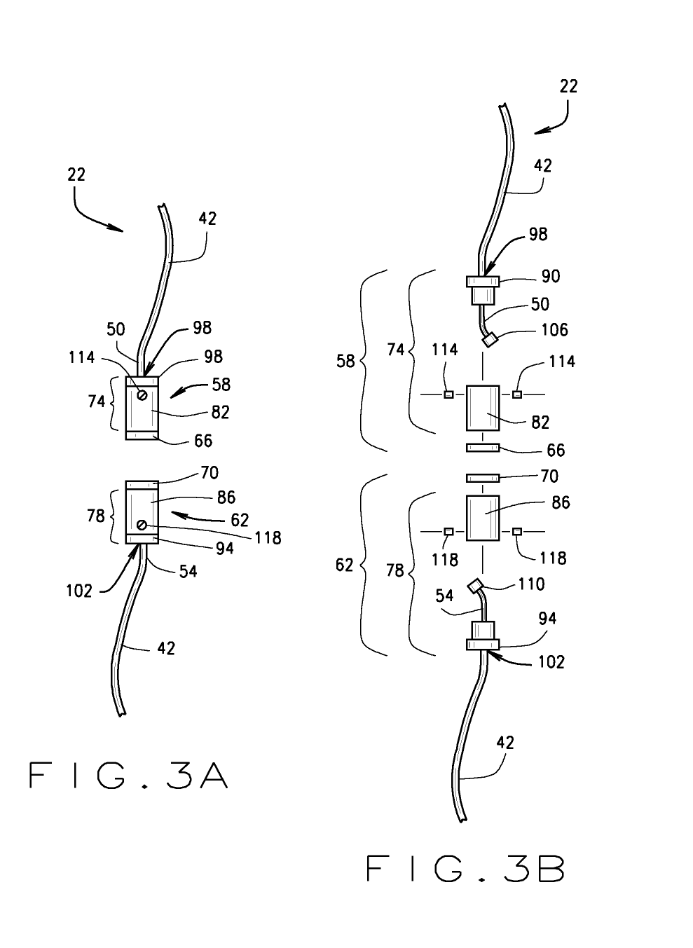

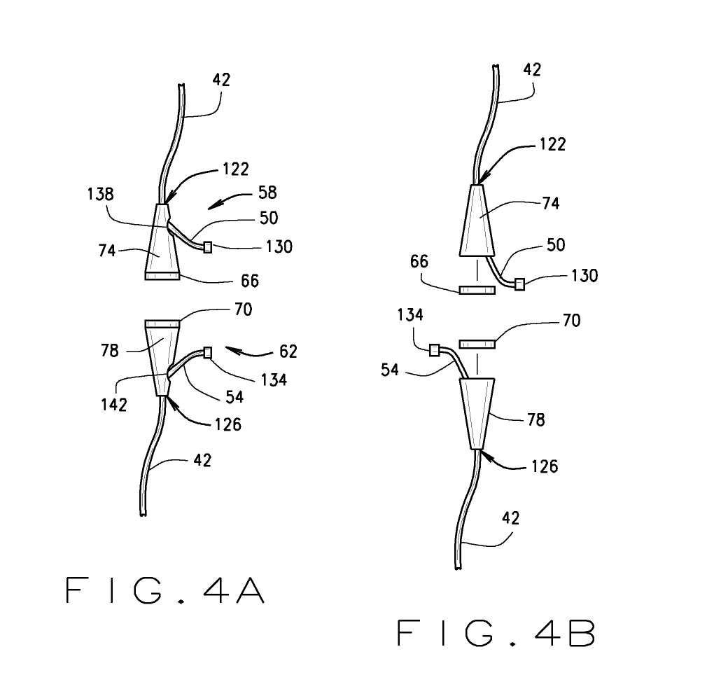

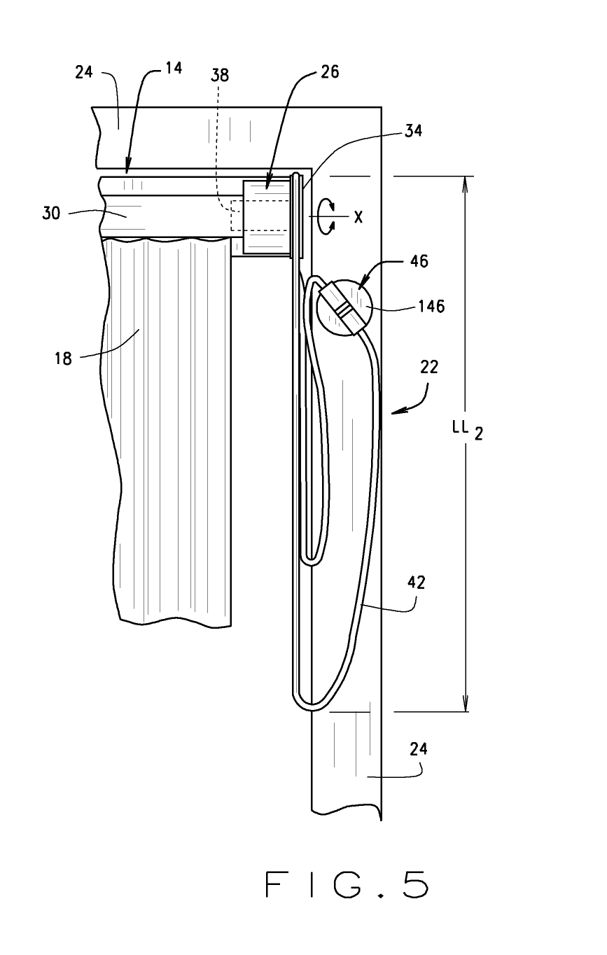

Referring now to FIGS. 3A, 3B, 4A and 4B, the first and second connectors 58 and 62 can each be any magnetic connector suitable for connecting to the respective clutch cord first and second ends 50 and 54 and magnetically coupling together.

For example, as illustrated in FIGS. 3A and 3B, in various embodiments, the first and second connector bodies 74 and 78 can respectively include a first and second housing 82 and 86, e.g., cylindrical housing, having the first and second magnets 66 and 70 disposed at the respective distal end thereof. Additionally, the first and second connector bodies 74 and 78 can respectively include a first and second end cap 90 and 94 connectable to a proximal end of the respective first and second body housings 82 and 86. The first and second end caps 90 and 94 respectively include a first and second aperture 98 and 102 through which the respective first or second clutch cord ends 50 and 54 can be inserted.

Furthermore, the first and second connector bodies 74 and 78 can respectively include a first and second cord retention means 106 and 110 structured and operable to fixedly retain the respective first and second end caps 90 and 102 on the respective first or second ends 50 and 54 of the clutch cord 42. The first and second cord retention means 106 and 110 can be any device, component, apparatus, system or mechanism suitable to fixedly retain the respective first and second end caps 90 and 102 on the respective first and second clutch cord ends 50 and 54.

For example, in various embodiments, each of the first and second retention means 106 and 110 can include a washer through which the respective clutch cord ends 50 and 54 are inserted and a knot tied in the respective clutch cord ends 50 and 54. Accordingly, the knots prevent the respective clutch cord ends 50 and 54 from pulling through respective washers, and the washers prevent the respective clutch cord ends 50 and 54 from pulling through respective end cap apertures 98 and 102, thereby retaining the respective end caps 90 and 102 on the respective clutch cord ends 50 and 54. Alternatively, in various other exemplary embodiments, the first and second retention means 106 and 110 can be a knot tied in the respective clutch cord ends 50 and 54 and sized to prevent the respective clutch cord ends 50 and 54 from pulling through respective end cap apertures 98 and 102, thereby retaining the respective end caps 90 and 102 on the respective clutch cord ends 50 and 54. In yet other exemplary embodiments, the first and second retention means 106 and 110 can be a compression fitting fixedly attached to the respective clutch cord ends 50 and 54, e.g., compressed on to the respective clutch cord ends 50 and 54, such that the respective clutch cord ends 50 and 54 are prevented from pulling through respective end cap apertures 98 and 102, thereby retaining the respective end caps 90 and 102 on the respective clutch cord ends 50 and 54.

Still further, the first and second connector bodies 74 and 78 can respectively include one or more first and second end cap retention means 114 and 118 structured and operable to fixedly retain the respective first and second end caps 90 and 102 on the proximal end of the respective first or second connector body housings 82 and 86. The first and second end cap retention means 114 and 118 can be any device(s), component(s), apparatus(es), system(s) or mechanism(s) suitable to retain the respective first and second end caps 90 and 102 on the proximal end of the respective first or second connector body housings 82 and 86.

For example, in various embodiments, the first and second end cap retention means 114 and 118 can comprise set screws that are threadable through one or more apertures in the side of the respective first or second connector body housings 82 and 86 to fixedly retain the respective end caps 90 and 102 on the proximal ends of the respective first and second body housings 82 and 86. Alternatively, in various other exemplary embodiments, the first and second end cap retention means 114 and 118 can comprise glue suitable to fixedly retain the respective end caps 90 and 102 on the proximal ends of the respective first and second body housings 82 and 86. Or, in various other exemplary embodiments, the first and second end cap retention means 114 and 118 can comprise sonic welds, whereby the end caps 90 and 94 are sonically welded to the respective body housings 82 and 86 to fixedly retain the respective end caps 90 and 102 on the proximal ends of the respective body housings 82 and 86.

In yet other exemplary embodiments, the first and second end cap retention means 114 and 118 can comprise rivets, whereby the end caps 90 and 94 are riveted to the respective body housings 82 and 86 to fixedly retain the respective end caps 90 and 102 on the proximal ends of the respective body housings 82 and 86. Or, in still yet other exemplary embodiments, the first and second end cap retention means 114 and 118 can comprise threads disposed on, or in, the end caps 90 and 94 and on, or in, the first and second housings 82 and 86, whereby the end caps 90 and 94 are threadingly engaged with the housings 82 and 86 to fixedly retain the respective end caps 90 and 102 on the proximal ends of the respective body housings 82 and 86.

Thus, in such embodiments, as illustrated in FIGS. 3A and 3B, to connect, or attach, the first and second connectors 58 and 62 to the respective first and second clutch cord ends 50 and 54, the clutch cord ends 50 and 54 are inserted through the apertures 98 and 102 of the respective first and second end caps 90 and 94. Subsequently, the first and second cord retention means 106 and 110 are disposed, connected, attached or formed on the respective first and second clutch cord ends 50 and 54 to retain the respective first and second end caps 90 and 102 on the clutch cord ends 50 and 54. After the first and second end caps 90 and 102 are on the respective first and second clutch cord ends 50 and 54, the end caps 90 and 102 are fixedly retained on the proximal ends of the respective body housings 82 and 86, thereby connecting, or attaching, the first and second connectors 58 and 62 to the respective first and second clutch cord ends 50 and 54.

Referring now to FIGS. 4A and 4B, in various other embodiments, the first and second connector bodies 74 and 78 can be formed as a single structure respectively including a first and second aperture 122 and 126 disposed in the proximal ends of the respective first and second connector bodies 74 and 78. The respective clutch cord first and second ends 50 and 54 can be inserted through the respective first and second aperture 122 and 126. Additionally, in such embodiments, the first and second connector bodies 74 and 78 can respectively include a first and second cord retention means 130 and 134 structured and operable to fixedly retain the respective first and second connector bodies 74 and 78 on the respective first or second ends 50 and 54 of the clutch cord 42. The first and second cord retention means 130 and 134 can be any device, component, apparatus, system or mechanism suitable to fixedly retain the respective first and second connector bodies 74 and 78 on the respective first and second clutch cord ends 50 and 54.

For example, in various embodiments, each of the first and second retention means 130 and 134 can include a washer through which the respective clutch cord ends 50 and 54 are inserted and a knot tied in the respective clutch cord ends 50 and 54. Accordingly, the knots prevent the respective clutch cord ends 50 and 54 from pulling through respective washers, and the washer prevent the respective clutch cord ends 50 and 54 from pulling through the respective connector body apertures 122 and 126, thereby retaining the respective connector bodies 74 and 78 on the respective clutch cord ends 50 and 54. Alternatively, in various other exemplary embodiments, the first and second retention means 130 and 134 can be a knot tied in the respective clutch cord ends 50 and 54 and sized to prevent the respective clutch cord ends 50 and 54 from pulling through respective connector body apertures 122 and 126, thereby retaining the respective connector bodies 74 and 78 on the respective clutch cord ends 50 and 54. In yet other exemplary embodiments, the first and second retention means 130 and 134 can be a compression fitting fixedly attached to the respective clutch cord ends 50 and 54, e.g., compressed on to the respective clutch cord ends 50 and 54, such that the respective clutch cord ends 50 and 54 are prevented from pulling through respective connector body apertures 122 and 126, thereby retaining the respective connector bodies 74 and 78 on the respective clutch cord ends 50 and 54.

Referring particularly to FIG. 4B, in various implementations, the first and second magnets 66 and 70 can be disposed on the distal end of the respective first and second connector bodies 74 and 78 subsequent to the clutch cord first and second ends 50 and 54 being inserted through the respective first and second apertures 122 and 126 and the first and second cord retention means 130 and 134 being disposed on the respective clutch cord first or second ends 50 and 54, as described above. In such implementations, the first and second magnets 66 and 70 can be subsequently disposed, in any suitable manner, on the distal end of the respective first and second connector bodies 74 and 78. For example, the first and second magnets 66 and 70 can be glued, ultrasonically welded, snapped, screwed, friction fitted, etc., into or on the distal ends of the respective connector bodies 74 and 78.

Referring particularly to FIG. 4A, in various implementations, the first and second magnets 66 and 70 can be disposed on the distal end of the respective first and second connector bodies 74 and 78, as described above, prior to the clutch cord first and second ends 50 and 54 being inserted through the respective first and second apertures 122 and 126 and the first and second cord retention means 130 and 134 being disposed on the respective clutch cord first or second ends 50 and 54, as described above. In such embodiment, the first and second connector bodies 74 and 78 can include a respective first and second side port 138 and 142 through which the respective clutch cord first and second ends 50 and 54 can be extended after the clutch cord first and second ends 50 and 54 have been inserted through the respective first and second connector body apertures 122 and 126. More specifically, the first and second clutch cord ends 50 and 54 can be inserted through the respective first and second connector body apertures 122 and 126 and then through the respective first and second side ports 138 and 142.

Thereafter, the respective first and second cord retention means 130 and 134 can be disposed on the respective clutch cord first or second ends 50 and 54, as described above. Subsequently, the first and second clutch cord ends 50 and 54 and the first and second cord retention means 130 and 134 can be pulled into an interior of the respective first and second connector bodies 74 and 78 to thereby retain the first and second connector bodies 74 and 78 on the respective first and second clutch cord ends 50 and 54.

Referring now to FIG. 5, in various embodiments, the window covering system 10 can further include a safety clutch cord holding button 146 that is structured and operable to hold the safety clutch cord 22 in a stored position. That is, the safety clutch cord holding button 146 is structured and operable to hold the safety clutch cord 22 in a position wherein the safety clutch cord 22, i.e., the closed loop clutch cord 42 and coupled clutch cord safety coupling 46, is out of the reach of small children. The safety clutch cord holding button 146 comprises a metallic plate that is attachable to the window opening structure 24, a suitable surface of the head unit 14, or any other surface surrounding the window opening structure. The safety clutch cord holding button 146 is attachable to any of the surfaces/structures via any suitable attaching means, such as glue, nails, screws, double-sided tape, etc.

In operation, the safety clutch cord holding button 146 can be attached to any of the surfaces/structures at a height near the height of the head unit 14. Then, to place the safety clutch cord in the stored position, the safety clutch cord 22 can be operated by applying longitudinal force to any portion of the closed loop clutch cord 42, as described above, to position the clutch cord safety coupling 46 at or near a bottom, or lowest portion, of the closed loop clutch cord 42. The clutch cord safety coupling 46 can then be lifted and placed in close proximity to the safety clutch cord holding button 146. The attractive magnetic flux field generated by the first and/or second magnets 66 and/or 70 will draw, or pull, the clutch cord safety coupling 46 into contact with metallic safety clutch cord holding button 146. Furthermore, the attractive magnetic flux field generated by the first and/or second magnets 66 and/or 70 will hold, or retain, the clutch cord safety coupling 46 in contact with metallic safety clutch cord holding button 146 until sufficient force is applied to remove the clutch cord safety coupling 46 from the safety clutch cord holding button 146.

Importantly, when the safety clutch cord 22 is placed in the stored position, the loop length LL of safety clutch cord 22 is substantially shortened, e.g., approximately folded in half. The loop length LL of the safety clutch cord 22 in an unstored position is illustrated in FIG. 2A as LL₁, while the loop length of the safety clutch cord 22 in the stored position, via the safety clutch cord holding button 146, is illustrated in FIG. 5 as LL₂. Accordingly, one skilled in the art would readily and clearly understand that LL₂ is substantially shorter than LL₁. Moreover, by substantially shortening the closed loop length LL of the safety clutch cord 22, the safety clutch cord 22 is configured to be out of the reach of small children.

Referring now to FIG. 6, as described above, the window covering system 10 generally includes a head unit 14, a window covering 18 and the clutch cord 42, e.g., the safety clutch cord 22. In various implementations, the window covering 18 can comprise a folding shade, e.g., a shade such as that commonly known as a Roman shade, wherein the window covering system 10 includes a plurality of safety lift cord assemblies 148 structured and operable to raise the shade 18 via operation of the clutch cord 42, e.g., the safety clutch cord 22. Moreover, each safety lift cord assembly 148 includes a safety lift cord 150 structured and operable to separate into two sections upon application of a certain force to the respective safety lift cord 150, as described below.

In such embodiments, the window covering movement mechanism 30 comprises a cylindrical barrel, tube or rod, hereafter referred to as the shade movement barrel 30, to which an upper end of each safety lift cord 150 is connected. An opposing lower end of each safety lift cord 150 is attached to a bottom portion 154 of the shade 18. An opposing top portion of the shade 18 is disposed adjacent and connected to a portion of the head unit 14, e.g., connected to the head unit housing 32. The shade movement barrel 30 is engaged with the drive spindle 38 such that rotation of the drive wheel 34 rotates the shade movement barrel 30, thereby causing the safety lift cords 150 to wrap around, or unwrap from, the shade movement barrel 30, depending on the direction in which the drive wheel 34 is rotated. Hence, each safety lift cord 150 is connected to the shade movement barrel 30 such that operation of the clutch mechanism 26, via operation of the safety clutch cord 22, will cause at least a portion of the shade 18 to move, or transition, from one position to another. Particularly, the shade movement barrel 30 is engaged with the drive spindle 38 such that rotation of the drive wheel 34 about an X axis will rotate the drive spindle 38 about the X axis, which will rotate the shade movement barrel 30 to move at least a portion of the shade 18 between various opened and closed positions.

More particularly, rotation of the drive wheel 34 in a first direction, and the resulting rotation for drive spindle 38, will operate the shade movement barrel 30 to retract the safety lift cords 150 causing at least a portion of the shade 18 to be raised from a first position, which can be any possible closed position of the respective portion of the shade 18, to a second position, which can be any other possible opened position of the respective portion of the shade 18. Similarly, rotation of the drive wheel 34 in a second direction that is opposite the first direction, and the resulting rotation for drive spindle 38, will operate the shade movement barrel 30 to extend the safety lift cords 150 causing at least a portion of the shade 18 to be lowered from a first position, which can be any possible opened position of the respective portion of the shade 18, to a second position, which can be any possible closed position of the respective portion of the shade 18. Hence, rotation of the drive wheel 34 will operate the shade movement barrel 30 to retract or extend the safety lift cords 150, thereby causing at least a portion of the shade 18 to move between any possible opened or closed position of the respective portion of the shade 18 and any other possible opened or closed position of the respective portion of the shade 18.

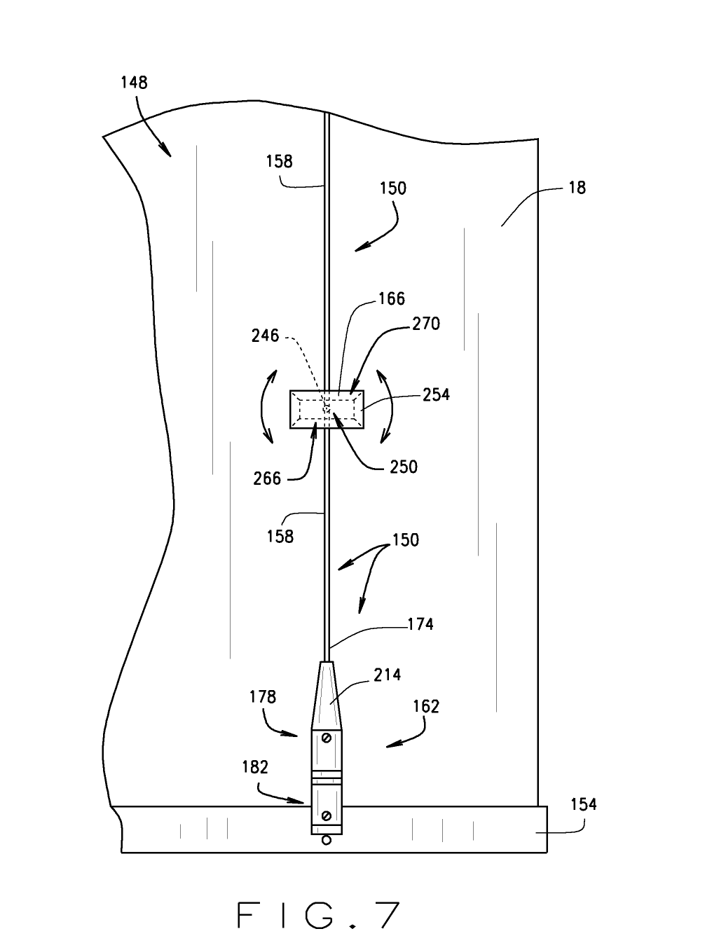

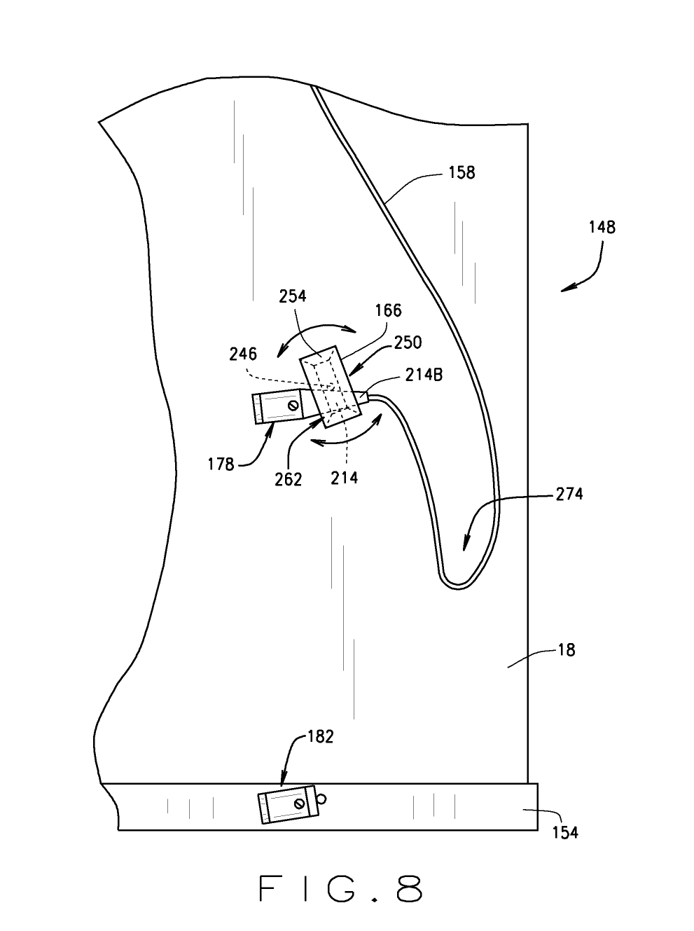

With additional reference to FIGS. 7 and 8, each safety lift cord assembly 148 includes a respective safety lift cord 150 and a plurality of rotatable guide rings 166 that are rotatably connectable to the shade 18. Each safety lift cord 150 includes a lift cord 158 and a safety lift cord bottom safety coupling 162. An upper end 170 of each lift cord 158, i.e., and upper end of the safety lift cord 150, is connected to the shade movement barrel 30, as described above, and an opposing lower end 174 of each lift cord 158 is connectable to the respective lift cord bottom safety coupling 162, as described further below. Each lift cord bottom safety coupling 162 is connectable to the bottom portion 154 of the shade 18 such that the lower end 174 of each safety lift cord 150 is connectable to the shade bottom portion 154. More particularly, each lift cord bottom safety coupling 162 is structured and operable to detachably connect each safety lift cord lower end 174 to the shade bottom portion 154. Each lift cord 158 can comprise any flexible device, mechanism or apparatus, e.g., cord, thread, wire, string, etc., suitable to impart forces on the shade bottom portion 154 sufficient to raise and lower the shade 18 as the shade movement barrel 30 is rotated via operation of the clutch cord 22, as described above.

Referring now to FIGS. 7, 8, 9A and 9B, each lift cord bottom safety coupling 162 includes a first connector 178 connectable to the lower end 174 of the lift cord 158, and a second connector 182 connectable to the bottom portion 154 of the shade 18. Each lift cord bottom safety coupling 162 additionally includes a first magnet 186 disposed at the distal end of a body 194 of the first connector 178, and a second magnet 190 disposed at the distal end of a body 198 of the second connector 182. It should be understood that as used herein, the term lower end 174 refers to the end portion of each respective lift cord 158, e.g., the portions of the lift cord 158 near the respective terminal end of the lift cord 158. The first and second magnets 186 and 190 can be disposed, i.e., mounted, connected, coupled or attached, to the distal ends of the respective connector bodies 194 and 198 in any suitable fashion. For example, the first and second magnets 186 and 190 can be glued, ultrasonically welded, snapped, screwed, friction fitted, etc., into or on the distal ends of the respective connector bodies 194 and 198.

Each first connector 178 can be connected to the respective lift cord lower end 174 in any manner suitable to fixedly retain the first connector 178 on the respective lift cord lower end 174, as described below. Similarly, each second connector 182 can be connected to the shade bottom portion 154 in any manner suitable to fixedly retain the second connector 182 on shade bottom portion 154, as described below. Additionally, the first and second magnets 186 and 190 are disposed on the distal ends of the respective first and second connector bodies 194 and 198 such that when placed in close proximity to each other, an attractive magnetic flux field of a predetermined force, or strength, is generated between the first and second magnets 186 and 190. Accordingly, in response to the attractive magnetic flux field, the first and second magnets 186 and 190, and hence, first and second connectors 178 and 182, magnetically connect when brought within close proximity to each other, thereby coupling the shade bottom portion 154 to each respective safety lift cord 150. Hence, when each of the first and second connectors 178 and 182 are magnetically coupled, each respective safety lift cord 150 is operable to raise and lower the shade 18, via operation of the clutch cord 42, e.g., the safety clutch cord 22, as described above.

More particularly, the first and second magnets 186 and 190 are selected to have a magnetic material structure or composition that will generate a predetermined amount of attractive force when placed in close proximity to each other. That is, the first and second magnets 186 and 190 are selected to have magnetic material structures or compositions that will generate an attractive magnet flux field sufficient to maintain connection of the first and second connectors 178 and 182 until a predetermined amount of longitudinal force is applied to either of the first or second connector 178 or 182, via application of longitudinal force to any portion of the respective lift cord 158. The predetermined amount of longitudinal force applied to either of the first or second connector 178 or 182 that will cause the first and second connectors 178 and 182 to decouple, is referred to herein as the predetermined lift cord bottom coupling threshold force.

Still more specifically, the first and second connectors 178 and 182 are magnetically connectable to each other, via the first and second magnets 186 and 190, with an amount of attractive force such that application of a longitudinal force to the respective lift cords 158 that is below the lift cord bottom coupling threshold force will operate, i.e., raise and lower, the shade, as described above. However, application of a longitudinal force equal to or greater than the lift cord bottom coupling threshold force will decouple, i.e., separate or pull apart, the first and second connectors 178 and 182, thereby severing the respective safety lift cord 150.

Still yet more specifically, when a longitudinal force below the predetermined lift cord bottom coupling threshold force is applied to either of the first or second connectors 178 or 182 of the safety lift cords 150, via rotation of the shade movement barrel 30 as controlled by operation of the clutch cord 42, the first and second connectors 178 and 182 will remain connected and the resulting movement of the safety lift cords 150 will raise or lower the shade 18. Conversely, when a longitudinal force greater than or equal to the predetermined lift cord bottom coupling threshold force is applied to either of the first or second connectors 178 or 182 of any of the safety lift cords 150, via application of a longitudinal force greater than or equal to the predetermined lift cord bottom coupling threshold force to any portion of the respective safety lift cord 150, the first and second connectors 178 and 182 will decouple severing the respective safety lift cord 150.

The lift cord bottom coupling threshold force is predetermined, based on the structure of the shade movement barrel 30, and the structure and weight of the shade 18, to be a force sufficient to retain the magnetic connection of each of the first and second connectors 178 and 182 of the respective window covering system 10 while a longitudinal force sufficient to raise or lower the shade 18 from a first position to a second position is applied to lift cords 158 collectively. Conversely, the predetermined lift cord bottom coupling threshold force is insufficient to retain the magnetic connection of any respective magnetically coupled first and second connectors 178 and 182 when a longitudinal force greater than the lift cord bottom coupling threshold force is applied to any portion of the respective safety lift cord 150. For example, the predetermined lift cord bottom coupling threshold force is selected to be sufficient to retain the magnetic coupling of each lift cord bottom safety coupling 162 during raising and lowering of the shade 18, as described above. However, the lift cord bottom coupling threshold force is additionally selected such that if a child were to have their arm, leg, or worse, begin to become entangled in any one or more of the lift cords 158, the resulting force on the respective safety lift cord(s) 150 would be greater than the predetermined lift cord bottom coupling threshold force such that the first and second connectors 178 and 182 of the respective lift cord bottom safety coupling(s) 162 would easily and readily decouple, severing the respective safety lift cord(s) 150, thereby allowing the child's arm or leg to fall free from the severed lift cord 158.

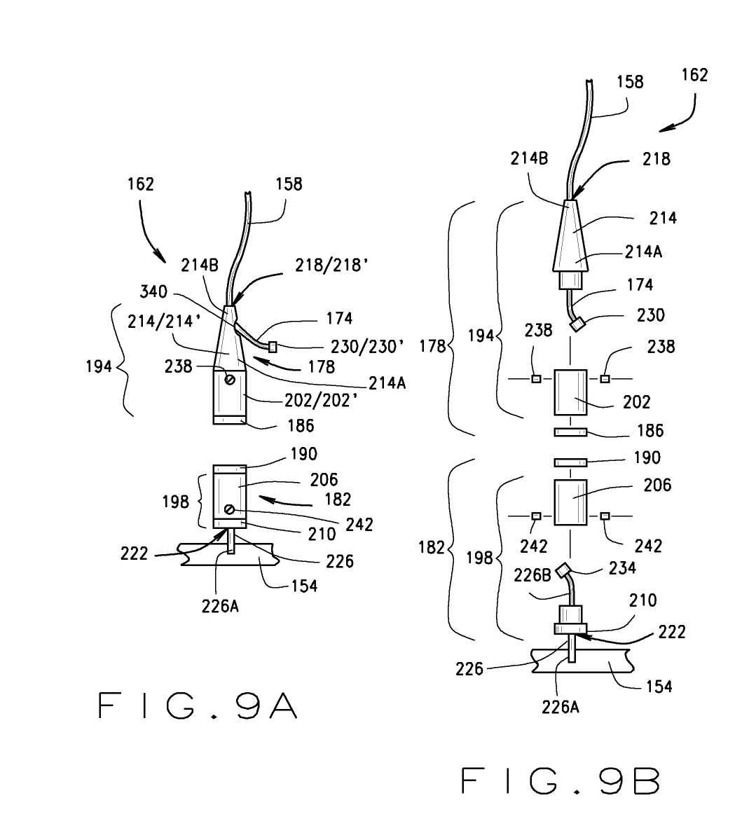

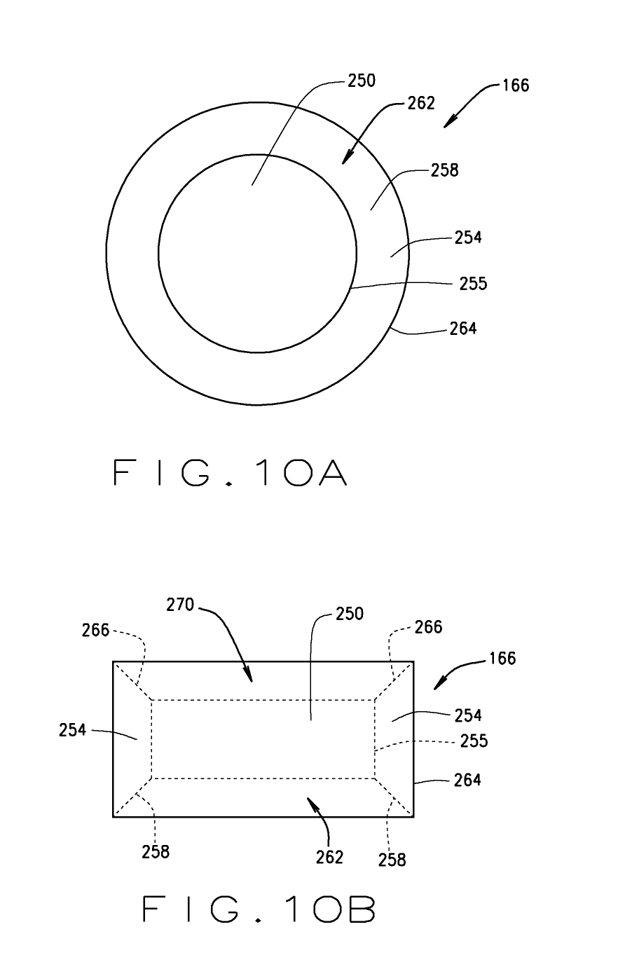

Referring now to FIGS. 9A and 9B, the first and second connectors 178 and 182 can each be any magnetic connector suitable for magnetically coupling together to connect the respective lift cord 158 to the shade bottom portion 154. For example, in various embodiments, the first and second connector bodies 194 and 198 of each lift cord bottom safety coupling 162 respectively includes a first and second housing 202 and 206, e.g., cylindrical housings, having the first and second magnets 186 and 190 disposed at the respective distal end thereof. Additionally, each second connector body 198 includes an end cap 210 that is connectable to a proximal end of the respective second connector body housing 206. Importantly, each first connector body 194 includes a conical end cap 214 that is connectable to a proximal end of the respective first connector body housing 202. Each conical end cap 214 is structured to have a first end 214A that is connectable to the proximal end respective first connector body housing 202 and an opposing second end 214B that is smaller in diameter than the first end 214A and includes a lift cord aperture 218 through which the end portion 174 of the respective lift cord 158 can be inserted to connect the conical end cap 214 to the respective lift cord end portion 174, as described below.

More particularly, each conical end cap 214 is structured such that the first end 214A has an outside diameter that is substantially equal to the outside diameter of the respective first connector body housing 202 such that when each conical end cap 214 is connected to the respective first connector body housing 202 the resulting first connector body 194 has a substantially smooth transition between the conical end cap 214 and the respective first connector body housing 202. That is, each resulting first connector body 194 is formed to have a substantially smooth outer surface substantially free of abrupt changes in surface continuity or texture. Additionally, each conical end cap 214 is structured to be gradually tapered from the first end 214A to the second end 214B such that the outside diameter of the second end 214B is approximately equal to the outside diameter of the respective lift cord end portion 174.

In various embodiments, each bottom safety coupling second connector 182 additionally includes a fastening device 226 that is structured and operable to connect each respective second connector body end cap 210, and hence, the respective lift cord bottom safety coupling second connector 182, to the shade bottom portion 154. Each fastening device 226 can be a cord, string, wire, chain, tie, nylon connector, or any other device suitable for connecting each respective second connector body end cap 210 to the shade bottom portion 154. In various implementations, each second connector body end cap 210 can include a fastening device aperture 222 through which the respective fastening device 226 can be inserted. In such implementations, each fastening device 226 can include a first end portion 226A that is connectable to the shade bottom portion 154 and a second end portion 226B that can be inserted through the respective second connector body end cap aperture 222 to connect the respective second connector body end cap 210 to the shade bottom portion 154, as described below. For example in various embodiments, each fastening device 226 can comprise a cord, similar in construction to the lift cords 158, having the first end portion 226A that is connectable to the shade bottom portion 154 and the second end portion 226B that can be inserted through the respective second connector body end cap aperture 222 to connect the respective second connector body end cap 210 to the respective fastening cord 226, as described below.

In various embodiments, the first and second connector bodies 194 and 198 of each bottom safety coupling 162 can respectively include a first and second cord retention means 230 and 234. In such embodiments, the first retention means 230 is structured and operable to fixedly retain the conical end cap 214 on the lift cord lower end 174 and the second retention means 234 is structured and operable to fixedly retain the second connector body end cap 210 on the fastening device 226, e.g., on the fastening cord second end portion 226B. The first and second cord retention means 230 and 234 can be any device, component, apparatus, system or mechanism suitable to respectively fixedly retain the respective conical and second connector body end caps 214 and 210 on the lift cord lower end 174 and the fastening device 226.

For example, in various embodiments, each of the first and second retention means 230 and 234 can include a washer through which the respective lift cord lower end 174 and the respective fastening device 226, e.g., the fastening cord second end portion 226B, are inserted. Subsequently, a knot can be tied in each lift cord lower end 174 and fastening cord second end portion 226B. Accordingly, the knots prevent the lift cord lower ends 174 and fastening cord second end portions 226B from pulling through respective washers, and the washers prevent the lift cord lower ends 174 and fastening cord second end portions 226B from pulling through respective conical end cap apertures 218 and second connector body end cap apertures 222, thereby retaining the conical end caps 214 and the second connector body end caps 210 on the respective lift cord lower ends 174 and fastening cord second end portions 226B.

Alternatively, in various other exemplary embodiments, the first and second retention means 230 and 234 can be a knot tied in the lift cord lower ends 174 and fastening cord second end portions 226B and sized to prevent the lift cord lower ends 174 and fastening cord second end portions 226B from pulling through respective conical end cap apertures 218 and second connector body end cap apertures 222, thereby retaining the conical end caps 214 and the second connector body end caps 210 on the respective lift cord lower ends 174 and fastening cord second end portions 226B.

In yet other exemplary embodiments, the first and second retention means 230 and 234 can be a compression fitting fixedly attached to the lift cord lower ends 174 and fastening cord second end portions 226B, e.g., compressed onto the lift cord lower ends 174 and fastening cord second end portions 226B, such that the lift cord lower ends 174 and fastening cord second end portions 226B are prevented from pulling through respective conical end cap apertures 218 and second connector body end cap apertures 222, thereby retaining the conical end caps 214 and the second connector body end caps 210 on the respective lift cord lower ends 174 and fastening cord second end portions 226B.

Still further, each first body 194 can include one or more conical end cap retention means 238 structured and operable to fixedly retain each conical end cap 214 on the proximal end of each respective first body housing 202. Similarly, each second body 198 can include one or more second connector body end cap retention means 242 structured and operable to fixedly retain each second connector body end cap 210 on the proximal end of each respective second body housing 206. Each of the conical end cap retention means 238 and the second connector body end cap retention means 242 can be any device(s), component(s), apparatus(es), system(s) or mechanism(s) suitable to retain the respective conical and second connector body end caps 214 and 210 on the proximal end of the respective first or second connector body housings 202 and 206.

For example, in various embodiments, the conical and second connector body cap retention means 238 and 242 can comprise set screws that are threadable through one or more apertures in the side of the respective first or second connector body housings 202 and 206 to fixedly retain the respective conical and second connector body end caps 214 and 210 on the proximal ends of the respective first and second body housings 202 and 206. Alternatively, in various other exemplary embodiments, the conical and second connector body end cap retention means 238 and 242 can comprise glue suitable to fixedly retain the respective conical and second connector body end caps 214 and 210 on the proximal ends of the respective first and second body housings 202 and 206. Or, in various other exemplary embodiments, the conical and second connector body end cap retention means 114 and 118 can comprise sonic welds, whereby the conical and second connector body end caps 214 and 210 are sonically welded to the proximal ends of the respective first and second body housings 202 and 206.

In yet other exemplary embodiments, the conical and second connector body end cap retention means 238 and 242 can comprise rivets, whereby the conical and second connector body end caps 214 and 210 are riveted to the proximal ends of the respective first and second body housings 202 and 206 to fixedly retain the conical and second connector body end caps 214 and 210 on the proximal ends of the respective body housings 202 and 206. Or, in still yet other exemplary embodiments, the conical and second connector body end cap retention means 238 and 242 can comprise threads disposed on, or in, the conical and second connector body end caps 214 and 210 and on, or in, the first and second body housings 202 and 206, whereby the end caps 214 and 210 are threadingly engaged with the respective body housings 202 and 206 to fixedly retain the end caps 214 and 210 on the proximal ends of the respective body housings 202 and 206.

Thus, in such embodiments, as illustrated in FIGS. 9A and 9B, to connect, or attach, each bottom safety coupling first connector 178 to the respective lift cord lower ends 174, the respective lift cord lower ends 174 are inserted through the respective conical end cap apertures 218. Subsequently, the first retention means 230 are disposed, connected, attached or formed on the respective lift cord lower ends 174 to retain the respective conical end caps 214 on the lift cord lower ends 174. After the conical end caps 214 are retained on the lift cord lower ends 174, each conical end cap 214 is fixedly retained on the proximal end of the respective first connector body housing 202, thereby connecting, or attaching, the first connectors 178 to the lift cord lower ends 174.

Similarly, in such embodiments, to connect, or attach, each bottom safety coupling second connector 182 to the respective second connector fastening device 226, e.g., fastening cord second end portions, the respective fastening device second end portion 226B is inserted through the respective second connector body end cap aperture 222. Subsequently, the second retention means 234 are disposed, connected, attached or formed on the respective fastening device second end portion 226B to retain the respective second connector body end cap 210 on the respective fastening device second end portion 226B. Thereafter, each second connector body end cap 210 is fixedly retained on the proximal end of the respective second connector body housing 206, thereby connecting, or attaching, the second connectors 182 to the fastening device second end portions 226B. Subsequently, or prior, the fastening device first end portion 226A of each fastening device 226 is connected to the shade bottom portion 154 such that each bottom safety coupling second connector 182 is connected to the shade bottom portion 154.

Referring particularly to FIG. 9A, in various other embodiments, each first connector body 194 can be formed as a single structure having a conical proximal end portion 214′ and a cylindrical distal end portion 202′ and a lift cord aperture 218′ disposed in the proximal end of the conical portion 214′. Each respective lift cord lower end 174 can be inserted through the respective aperture 218′. Additionally, in such embodiments, each first connector body 194 can include a cord retention means 230′ structured and operable to fixedly retain each respective single structure first connector body 194 on the respective lift cord lower ends 174. As described above with regard to the first cord retention means 230, the cord retention means 230′ can be any device, component, apparatus, system or mechanism suitable to fixedly retain each single structure second connector body 194 on the respective lift cord lower ends 174.

In various implementations of such single structure first connector body embodiments, each first magnet 186 can be disposed on the distal end of the respective first connector cylindrical portion 202′ subsequent to the respective lift cord lower ends 174 being inserted through the respective apertures 218′ and the retention means 230′ being disposed on the respective lift cord lower ends 174, as described above. After each lift cord lower end 174 has been inserted through the respective apertures 218′ and the retention means 230′ have been disposed on the respective lift cord lower ends 174, the first magnets 186 can be disposed, in any suitable manner, on the distal ends of the respective first connector cylindrical portions 202′. For example, the first magnets 186 can be glued, ultrasonically welded, snapped, screwed, friction fitted, etc., into or on the distal ends of the respective first connector cylindrical portions 202′.

Alternatively, in such single structure first connector body embodiments, each first magnet 186 can be disposed on the distal end of the respective first cylindrical portion 202′, as described above, prior to each respective lift cord lower end 174 being inserted through the respective apertures 218′ and retention means 230′ being disposed on the respective lift cord lower ends 174. In such implementations, each first connector conical portion 214′ can include a side port 340 through which the respective lift cord lower end 174 can be extended after each respective each respective lift cord lower end 174 has been inserted through the respective aperture 218′ in the proximal end of the conical portion 214′. More specifically, each lift cord lower end 174 can be inserted through the respective apertures 218′ and then extended through the respective side port 340.

Thereafter, the cord retention means 230′ can be disposed on the respective lift cord lower ends 174, as described above. Subsequently, each lift cord lower end 174 and respective retention means 230′ can be pulled into an interior of the respective first connector body conical portion 214′ to thereby retain each first connector body 194 on the respective lift cord lower end 174.

Furthermore, in various embodiments, each bottom safety coupling second connector 182 can comprise a conical shaped second connector body 198 substantially identical in form and function to the safety clutch cord second connector body 78 described above with reference to FIGS. 4A and 4B.

Referring now to FIGS. 6, 7, 8 10A and 10B, as described above each safety lift cord assembly 148 includes a plurality of rotatable guide rings 166 rotatably connected to the shade 18. Each guide ring 166 can be rotatably mounted, or connected, to the shade 18 such that each guide ring 166 can freely pivot, or rotate, 360° in either direction about the point 246 at which each respective guide ring 166 is connected to the shade 18. The guide rings 166 can be rotatably connected to the shade using any fastening means such as rivets, thread, string, cord, plastic connectors, buttons, snaps, etc., suitable to freely rotate 360° in either direction about the respective connection points 246.

Each guide ring 166 includes a center aperture 250 through which a respective one of the lift cords 158 extends when the respective safety lift cord 150 is configured to operate the shade 18. That is, when the bottom safety coupling first and second connectors 178 and 182 are magnetically coupled, as described above, the respective lift cord 158 of each respective safety lift cord 150 is threaded through the center aperture 250 of each of a plurality of the guide rings 166 that are connected to the shade 18 in a longitudinally aligned arrangement between where the respective bottom safety coupling second connector 182 is connected to the shade bottom portion 154 and where the respective lift cord upper end 170 is connected to the shade movement barrel 30, as illustrated in FIGS. 6 and 7. Hence, during operation of the shade 18, i.e., raising and lowering of the shade 18 via rotation of the shade movement barrel 30 with the bottom safety coupling first and second connectors 178 and 182 magnetically coupled, the longitudinally aligned guide rings 166 restrict lateral movement of the respective lift cord 158. That is, the longitudinally aligned guide rings 166 guide the respective lift cord 158 during operation of the shade 18.

Each guide ring includes a sidewall 254 having a first beveled lateral surface 258 that defines a substantially concave, or funnel-like, sidewall first face 262 leading to the respective center aperture 250. Particularly, the side wall 254 is structured such that the first beveled lateral surface 258 extends radially inward and laterally inward from an exterior surface 264 of the sidewall 254 to an interior surface 255 of the sidewall 254, thereby providing a funnel-like, or substantially concave, sidewall first face 262. In various embodiments, the sidewall 254 of each guide ring further includes a second beveled lateral surface 266 that defines a substantially concave, or funnel-like, sidewall second face 270, opposite the first substantially concave sidewall first face 262, leading to the respective center aperture 250. Particularly, in such embodiments, the side wall 254 is structured such that the second beveled lateral surface 266 extends radially inward and laterally inward from the exterior surface 264 of the sidewall 254 to the interior surface 255 of the sidewall 254, thereby providing a funnel-like, or substantially concave, sidewall second face 270.

As described above, the first and second connectors 178 and 182 are magnetically connectable to each other, via the first and second magnets 186 and 190, with an amount of attractive force such that application of a longitudinal force to the respective lift cords 158 that is below the lift cord bottom coupling threshold force will operate, i.e., raise and lower, the shade, as described above, while, application of a longitudinal force equal to or greater than the lift cord bottom coupling threshold force will decouple, i.e., separate or pull apart, the first and second connectors 178 and 182, thereby severing the respective safety lift cord 150. For example, if a child were to have their arm, leg, or worse, begin to become entangled in any one or more of the lift cords 158, the resulting force on the respective safety lift cord(s) 150 would be greater than the predetermined lift cord bottom coupling threshold force such that the first and second connectors 178 and 182 of the respective lift cord bottom safety coupling(s) 162 would easily and readily decouple, severing the respective safety lift cord(s) 150, thereby allowing the child's arm or leg to fall free from the severed lift cord 158.

Moreover, if a longitudinal force greater than the threshold force is applied to any portion of any lift cord 158 the force on the respective lift cord 158 can pull the decoupled bottom safety coupling first connector 178 into contact with one or more of the rotatable ring guides 166 of the respective safety lift cord assembly 148. For example, if a child were to have their arm, leg, or worse, begin to become entangled in a lift cord 158, the resulting force on the respective safety lift cord 150 would decouple the respective bottom safety coupling first and second connectors 178 and 182, as described above. In such instances, the force applied to the lift cord 158 can continue creating a loop 274 in the lift cord 158 and pulling the respective bottom safety coupling first connector 178 into contact with one or more of the guide rings 166 of the respective safety lift cord assembly 148.

Importantly, when the bottom safety coupling first connector 178 is pulled into contact with any of the respective guide rings 166, the second end 214B, i.e., the vertex, of the respective first connector conical end cap 214, or conical portion 214′, will enter the center aperture(s) 150 of the respective guide ring(s) 166 and the respective first connector 178 will pass through the center aperture(s) 150 of the respective guide ring(s) 166 allowing the first connector 178 to dangle free, thereby eliminating the loop 274. Hence, any object that may begin to become entangled in one of the lift cords 158 and applies a force to the respective lift cord 158 that is greater than the threshold force, e.g., a child's arm, leg or worse, will easily and readily decouple the bottom safety coupling first and second connectors 178 and 182 and easily and readily pull the decoupled first connector 178 through one or more of the guide rings 166 of the respective safety lift cord assembly 148, until any loop 274 that may be created is eliminated, thereby allowing the object to separate from the respective lift cord 158 and prevent the object from becoming entangled in the respective lift cord 158.

Furthermore, as described above, each guide ring includes a substantially concave, or funnel-like, sidewall first face 262 and, in various embodiments, an opposing substantially concave, or funnel-like, sidewall second face 270. The combination of the first connector conical end cap 214, or conical portion 214′, and the substantially concave sidewall first face 262, or substantially concave sidewall second face 270, allow the respective second connector 178 to contact respective guide ring(s) 166 and easily pass through the respective center apertures 250 without, or nearly without, impedance or hindrance. That is, the tapered surface of the first connector conical end cap 214, or conical portion 214′, and the first beveled lateral surface 258 of the sidewall 254, or the second beveled lateral surface 266 of the sidewall 254, provide a substantially smooth, unimpeded and unhindered interaction between the first connector conical end cap 214, or conical portion 214′, and the sidewall concave face first 262, or the sidewall concave second face 270 as the respective second connector 178 is pulled into contact with respective guide ring(s) 166. Hence, as the respective second connector 178 is pulled into contact with respective guide ring(s) 166, the tapered surface of the first connector conical end cap 214, or conical portion 214′, and the first beveled lateral surface 258 of the sidewall 254, or the second beveled lateral surface 266 of the sidewall 254 easily and readily guide the respective second connector 178 through the respective guide ring center aperture(s) 250 without, or nearly without, impedance or hindrance. Therefore, any object that applies a force to a respective lift cord 158 greater than the threshold force, e.g., a child's arm, leg or worse, will be prevented from becoming entangled in the respective lift cord 158.

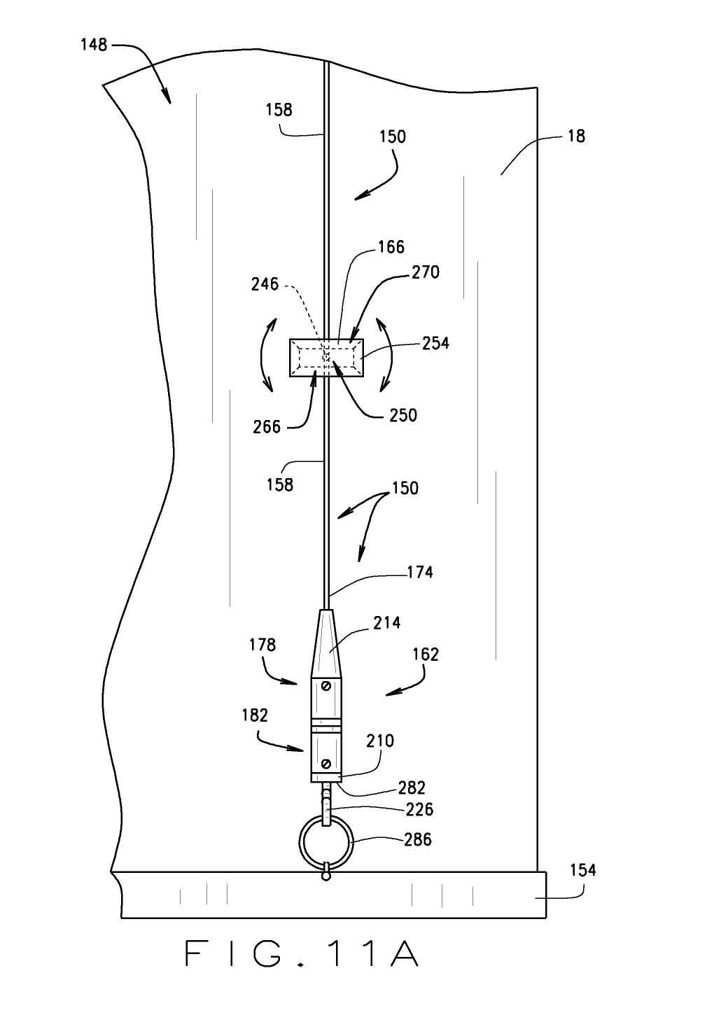

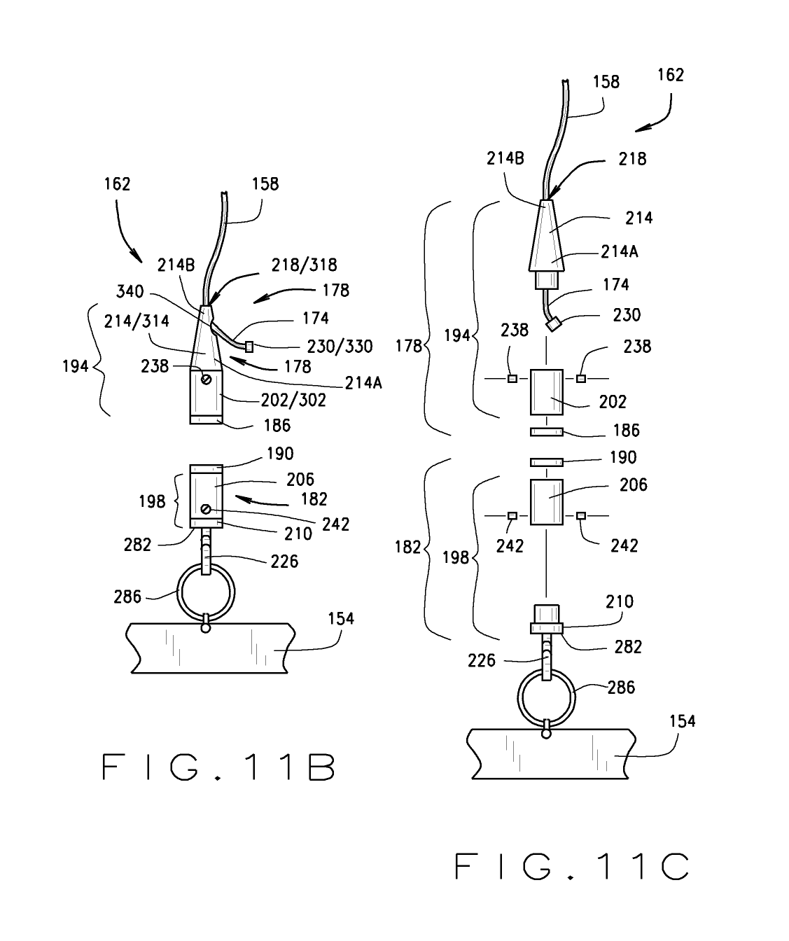

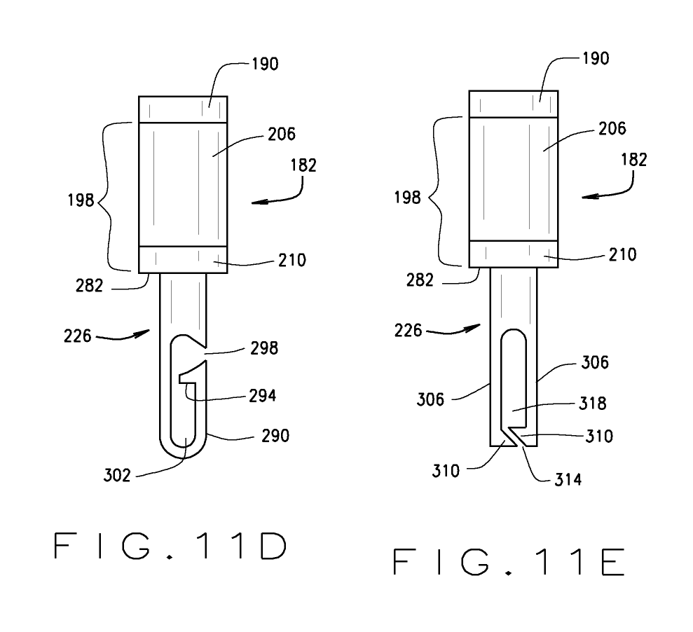

Referring now to FIGS. 11A, 11B and 11C, as described above, each bottom safety coupling second connector 182 can be connected to the shade bottom portion 154 in any manner suitable to fixedly retain the second connector 182 on shade bottom portion 154. As also described above, in various embodiments, each bottom safety coupling second connector 182 includes a fastening device 226 that is structured and operable to connect each respective second connector body end cap 210, and hence, the respective lift cord bottom safety coupling second connector 182, to the shade bottom portion 154. For example, in various implementations, each fastening device 226 can be a cord, string, wire, chain, tie, nylon connector, or any other device suitable for connecting each lift cord bottom safety coupling second connector 182 to the shade bottom portion 154. More particularly, in various implementations, as illustrated in FIGS. 11A, 11B, 11C, 11D and 11E, each fastening device 226 can comprise a nylon, plastic, or other material, clip that extends from a base 282 of the second connector body end cap 210 and is structured to be removably connectable to a lift cord bottom attachment device 286 that is connected to the bottom portion 154 of the respective shade 18.

In such implementations, each lift cord bottom attachment device 286 can be any device suitable for removably connecting the respective clip 226, i.e., fastening device 226, thereto such that each respective lift cord 158 will be operable to pull on the shade bottom portion 154, and hence, move at least a portion of the shade 18 between the first position and the second position when the first and second connectors 178 and 182 of lift cord bottom safety coupling 162 are magnetically connected, as described above. For example, in various embodiments, each lift cord bottom attachment device 286 can comprise a ring connected to the shade bottom portion 154 such that the respective clip 226 of the respective second connector 182 can be removably clipped, i.e., connected, to the respective ring 286. Alternatively, each lift cord bottom attachment device 286 can comprise a loop, tab, tag, grommet, post, hook or other suitable device, e.g., a thread, fabric, plastic, nylon, wire, metal, or other material loop, tab, tag, grommet, post, hook or other suitable device, having a portion thereof connected to the shade bottom portion 154 and another portion thereof suitable for connection of the respective clip 226.

The clips 226 can have any shape, size or geometry that is structured to be removably connectable to the respective lift cord bottom attachment devices 286. For example, as illustrated in FIG. 11D, in various embodiments, each clip 226 can have a hook and barb configuration wherein each clip 226 includes a hook 290 having a barb 294 formed at a distal end. In such embodiments, the lift cord bottom attachment device 286, e.g., a ring, can be inserted into a mouth 298 of the respective clip 226, pulled past the barb 294 and disposed within a reservoir 302 of the hook 290. The barb 294 prevents the lift cord bottom attachment device 286 from inadvertently disengaging from the respective clip 226 once the lift cord bottom attachment device 286 is disposed within the respective reservoir 302. Or, as a further example, as illustrated in FIG. 11E, in various embodiments, each clip 226 can have a tang and barb configuration wherein each clip 226 includes a pair of opposing tangs 306 having overlapping barbs 310 formed at distal ends of the respective tangs 306. In such embodiments, the lift cord bottom attachment device 286, e.g., a ring, can be inserted into a mouth 314 of the respective clip 226, pushed past the overlapping barbs 310 and disposed within a gap 318 between the respective tangs 306. The overlapping barbs 310 prevent the lift cord bottom attachment device 286 from inadvertently disengaging from the respective clip 226 once the lift cord bottom attachment device 286 is disposed within the gap 318.

As described above, the lift cord 158, i.e., the lift cord lower end 174, can be connected to the conical end cap 214, via any suitable bottom safety coupling first cord retention means 230, and the conical end cap 214 can be connected to the first connector body housing 202, via any suitable bottom safety coupling first cap retention means 238. Additionally, in various embodiments, the second connector body end cap 210, having the clip 226 extending therefrom, can be connected the second connector body housing 206, via any suitable bottom safety coupling second cap retention means 242. Alternatively, in various embodiments, the second connector body housing 206 and the second connector body end cap 210, having the clip 226 extending therefrom, can be integrally formed as a single, unitary structure.

Accordingly, once each bottom safety coupling second connector 182 is removably connected to the bottom portion 154 of the shade 18, via the clip 226, the bottom safety coupling 162 and hence, the respective safety lift cords 150 are operable to operate the shade 18 when the first and second connectors 178 and 182 of lift cord bottom safety coupling 162 are magnetically connected, as described above. Moreover, as described above, the first and second connectors 178 and 182 are magnetically connectable to each other, via the first and second magnets 186 and 190, with an amount of attractive force such that application of a longitudinal force to the respective lift cords 158 that is below the lift cord bottom coupling threshold force will operate, i.e., raise and lower, the shade, as described above. However, application of a longitudinal force equal to or greater than the lift cord bottom coupling threshold force will decouple, i.e., separate or pull apart, the first and second connectors 178 and 182, thereby severing the respective safety lift cord 150.

For example, the predetermined lift cord bottom coupling threshold force is selected to be sufficient to retain the magnetic coupling of each lift cord bottom safety coupling 162 during raising and lowering of the shade 18, as described above. However, the lift cord bottom coupling threshold force is additionally selected such that if a child were to have their arm, leg, or worse, begin to become entangled in any one or more of the lift cords 158, the resulting force on the respective safety lift cord(s) 150 would be greater than the predetermined lift cord bottom coupling threshold force such that the first and second connectors 178 and 182 of the respective lift cord bottom safety coupling(s) 162 would easily and readily decouple, severing the respective safety lift cord(s) 150, thereby allowing the child's arm or leg to fall free from the severed lift cord 158.

It in envisioned that in the various embodiments, described above, wherein each fastening device 226 comprises a clip 226 extending from the base 282 of the second connector body end cap 210, the bottom safety coupling 162 can be a retrofittable bottom safety coupling 162 that can be installed on existing shades 18 that were not manufactured with the safety lift cords 150. More specifically, in such embodiments, bottom safety couplings 162 can be added to the lift cords of an existing shade 18 to modify the respective shade 18 to include the severable safety lift cords 150. In such retrofit instances, the respective shade 18 will typically include a plurality of lift cords that are connected at an upper end to a shade movement barrel 30 and connected at lower ends to bottom portion of the respective shade, via a lift cord bottom attachment device 286, such as rings 286 exemplarily shown in FIGS. 11A, 11B and 11C. In order to modify the respective shade 18 to include the retrofit bottom safety couplings 162, the lower end of each lift cord is detached from the respective lift cord bottom attachment device 286, whereby the detached lower end of each lift cord becomes the lift cord lower end 174 described above. Thereafter, each lift cord lower end 174 can be connected to a respective bottom safety coupling first connector 178, as described above, and each respective bottom safety coupling second connector 182 can be connected, or clipped, to the lift cord bottom attachment device 286, via the respective clips 226, as described above. Subsequently, the bottom safety coupling first and second connectors 178 and 182 can be magnetically coupled, via magnets 186 and 190, as described above, to thereby retrofit the shade 18 with the safety lift cords 150 described herein.

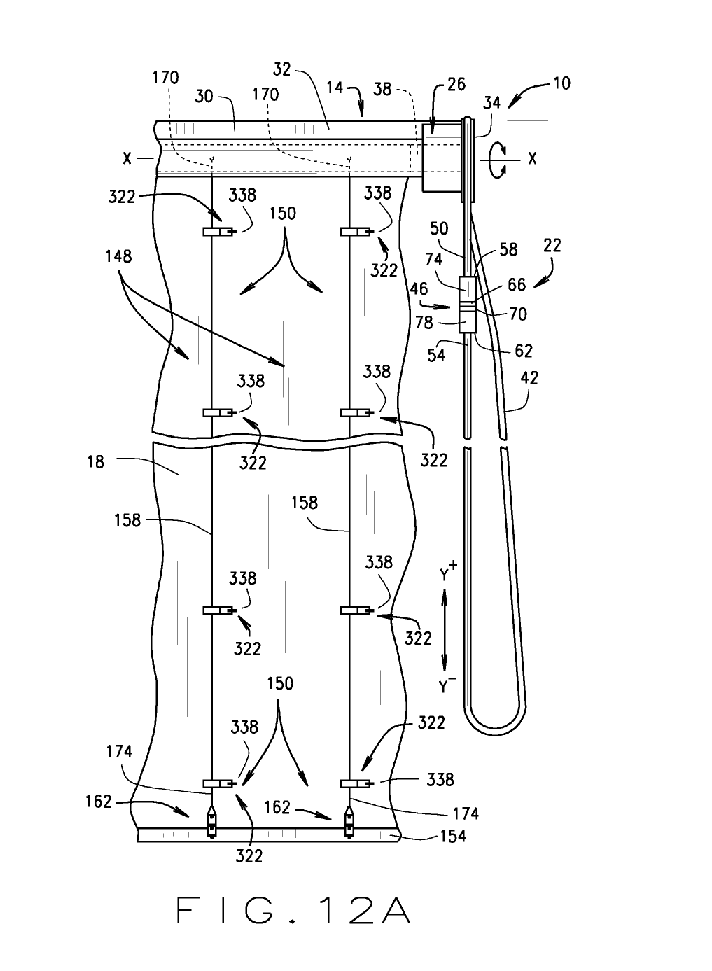

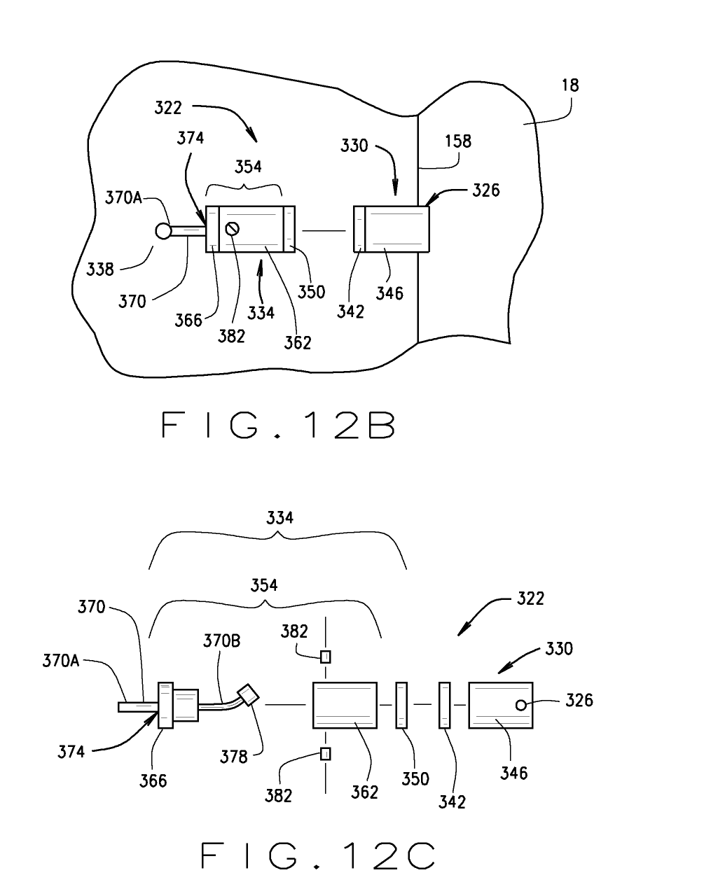

Referring now to FIGS. 12A, 12B and 12C, in various embodiments, each safety lift cord assembly 148 includes the respective safety lift cord 150, the respective safety lift cord bottom safety coupling 162 and a plurality of intermediate safety couplings 322 that are connectable to the shade 18. Each intermediate safety couplings 322 can be connected to the shade 18 using any suitable fastening means such as rivets, thread, string, cord, plastic connectors, clips, buttons, snaps, etc. Each intermediate safety coupling 322 includes a lift cord aperture 326 through which a respective one of the lift cords 158 extends when the respective safety lift cord 150 is configured to operate the shade 18. That is, when the bottom safety coupling first and second connectors 178 and 182 are magnetically coupled, as described above, the respective lift cord 158 of each respective safety lift cord 150 is threaded through the lift cord aperture 326 of each of a plurality of the intermediate safety couplings 322 that are connected to the shade 18 in a longitudinally aligned arrangement between where the respective bottom safety coupling second connector 182 is connected to the shade bottom portion 154 and where the respective lift cord upper end 170 is connected to the shade movement barrel 30, as illustrated in FIG. 12A.

Each respective lift cord aperture 328 is sized to allow the respective lift cord 150 to easily pass through, and move within, the respective lift cord aperture 326 as the respective lift cord is retracted and extended, via rotation of the shade movement barrel 30, as described above. Hence, during operation of the shade 18, i.e., raising and lowering of the shade 18 via rotation of the shade movement barrel 30 with the bottom safety coupling first and second connectors 178 and 182 magnetically coupled, the longitudinally aligned intermediate safety couplings 322, when magnetically coupled, as described below, restrict lateral movement of the respective lift cord 158. That is, the longitudinally aligned intermediate safety couplings 322 guide the respective lift cord 158 during operation of the shade 18.

With particular reference to FIGS. 12B and 12C, each lift cord intermediate safety coupling 322 includes a first connector 330 that includes the respective lift cord aperture 326 and a second connector 334 that is connectable to a respective intermediate portion 338 of the shade 18. Each lift cord intermediate safety coupling 322 additionally includes a first magnet 342 disposed at the distal end of a body 346 of the first connector 330, through which the lift cord aperture 326 extends, and a second magnet 350 disposed at the distal end of a body 354 of the second connector 334. The first and second magnets 342 and 350 can be disposed, i.e., mounted, connected, coupled or attached, to the distal ends of the respective connector bodies 346 and 354 in any suitable fashion. For example, the first and second magnets 342 and 350 can be glued, ultrasonically welded, snapped, screwed, friction fitted, etc., into or on the distal ends of the respective connector bodies 346 and 354.

Each second connector 334 can be connected to the respective intermediate portion 338 of the shade 18 in any manner suitable to fixedly retain the second connector 334 on the shade 18, as described below. Additionally, the first and second magnets 342 and 350 are disposed on the distal ends of the respective first and second connector bodies 346 and 354 such that when placed in close proximity to each other, an attractive magnetic flux field of a predetermined force, or strength, is generated between the first and second magnets 342 and 350. Accordingly, in response to the attractive magnetic flux field, the first and second magnets 342 and 350, and hence, first and second connectors 330 and 334, magnetically connect when brought within close proximity to each other, thereby coupling the shade intermediate portions 338 to each respective lift cord 158. Hence, when each of the first and second connectors 330 and 334 are magnetically coupled, each respective safety lift cord 150 is operable to raise and lower the shade 18, via operation of the clutch cord 42, e.g., the safety clutch cord 22, as described above.

More particularly, the first and second magnets 342 and 350 are selected to have a magnetic material structure or composition that will generate a predetermined amount of attractive force when placed in close proximity to each other. That is, the first and second magnets 342 and 350 are selected to have magnetic material structures or compositions that will generate an attractive magnet flux field sufficient to maintain connection of the first and second connectors 330 and 334 until a predetermined amount of longitudinal force, i.e., a force coaxial to a longitudinal axis of the respective intermediate safety coupling 322, and/or a lateral force, i.e., a force lateral to the longitudinal axis of the respective intermediate safety coupling 322, is applied to either of the respective first or second connector 330 or 334, via application of longitudinal and/or lateral force to any portion of the respective lift cord 158. The predetermined amount of longitudinal and/or lateral force applied to either of the first or second connector 330 or 334 that will cause the first and second connectors 330 and 334 to decouple, is referred to herein as the predetermined lift cord intermediate coupling threshold force. The predetermined lift cord intermediate coupling threshold force can be the same force values as or different than the predetermined lift cord bottom coupling threshold force, described above.

Still more specifically, the first and second connectors 330 and 334 are magnetically connectable to each other, via the first and second magnets 342 and 350, with an amount of attractive force such that application of a longitudinal and/or lateral force to the respective lift cords 158 that is below the lift cord intermediate coupling threshold force will operate the shade 18, i.e., raise and lower the shade 19, as described above. However, application of a longitudinal and/or lateral force equal to or greater than the lift cord intermediate coupling threshold force will decouple, i.e., separate or pull apart, the first and second connectors 330 and 334, thereby separating the respective safety lift cord 150 from the respective intermediate portions 338 of the shade 18.

Still yet more specifically, when a longitudinal and/or lateral force below the predetermined lift cord intermediate coupling threshold force is applied to either of the first or second connectors 330 or 334 of the safety lift cords 150, via rotation of the shade movement barrel 30 as controlled by operation of the clutch cord 42, the first and second connectors 330 and 334 will remain connected and the resulting movement of the safety lift cords 150 will raise or lower the shade 18. Conversely, when a longitudinal and/or lateral force greater than or equal to the predetermined lift cord intermediate coupling threshold force is applied to either of the first or second connectors 330 or 334 of any of the safety lift cords 150, via application of a longitudinal and/or lateral force greater than or equal to the predetermined lift cord intermediate coupling threshold force to any portion of the respective safety lift cord 150, the first and second connectors 330 and 334 will decouple separating the respective safety lift cord 150 from the respective intermediate portions 338 of the shade 18.

The lift cord intermediate coupling threshold force is predetermined, based on the structure of the shade movement barrel 30, frictional force applied to the first connector 330 by the respective lift cord 158 moving within the respective lift cord aperture 326 and the structure and weight of the shade 18, to be a force sufficient to retain the magnetic connection of each of the first and second connectors 330 and 334 of the respective window covering system 10 while a longitudinal force sufficient to raise or lower the shade 18 from a first position to a second position is applied to the lift cords 158 collectively. Conversely, the predetermined lift cord intermediate coupling threshold force is insufficient to retain the magnetic connection of any respective magnetically coupled first and second connectors 330 and 334 when a longitudinal and/or lateral force greater than the lift cord intermediate coupling threshold force is applied to any portion of the respective safety lift cord 150.

For example, the predetermined lift cord intermediate coupling threshold force is selected to be sufficient to retain the magnetic coupling of each lift cord intermediate safety couplings 322 during raising and lowering of the shade 18, as described above. However, the lift cord intermediate coupling threshold force is additionally selected such that if a child were to have their arm, leg, or worse, begin to become entangled in any one or more of the lift cords 158, the resulting force on the respective safety lift cord(s) 158 would be greater than the predetermined lift cord intermediate coupling threshold force such that the first and second connectors 330 and 334 of the respective lift cord intermediate safety coupling(s) 322 would easily and readily decouple, separating the respective safety lift cord 150 from the respective intermediate portions 338 of the shade 18 and severing the respective safety lift cord(s) 150 at the bottom safety coupling 162, as described above, thereby allowing the child's arm or leg to fall free from the severed lift cord 158.

With further reference to FIGS. 12B and 12C, the first and second connectors 330 and 334 can each be any magnetic connector suitable for magnetically coupling together to connect the respective lift cord 158 to the respective intermediate portion 338 of the shade 18. For example, in various embodiments, the first magnet 342 can be disposed at a distal end of the first connector body 346 and the second magnet 350 can be disposed at a distal end of housing 362, e.g., a cylindrical housing, of the second connector body 354. Additionally, each second connector body 354 includes an end cap 366 that is connectable to a proximal end of the respective second connector body housing 362.

In various embodiments, each intermediate safety coupling second connector 354 additionally includes a fastening device 370 that is structured and operable to connect each respective second connector body end cap 366, and hence, the respective lift cord intermediate safety coupling second connector 334, to the respective intermediate portion 338 of the shade 18. Each fastening device 370 can be a cord, string, wire, chain, tie, nylon, plastic or other material connector, or any other device suitable for connecting each respective second connector body end cap 366 to the respective intermediate portion 338 of the shade 18.

For example, in various implementations, each second connector body end cap 366 can include a fastening device aperture 374 through which the respective fastening device 370 can be inserted. In such implementations, each fastening device 370 can include a first end portion 370A that is connectable to the shade intermediate portion 338 and a second end portion 370B that can be inserted through the respective second connector body end cap aperture 374 to connect the respective second connector body end cap 366 to the respective shade intermediate portion 338, as described below. For example in various embodiments, each fastening device 370 can comprise a cord, similar in construction to the lift cords 158, having the first end portion 370A that is connectable to the respective shade intermediate portion 338, e.g., each first end portion 370A can be sewn to the respective intermediate shade portion 338, and the second end portion 370B that can be inserted through the respective second connector body end cap aperture 374 to connect the respective second connector body end cap 366 to the respective fastening cord 370, as described below.

In various embodiments, the second connector body 354 of each intermediate safety coupling 322 can include cord retention means 378. In such embodiments, the cord retention means 378 is structured and operable to fixedly retain the second connector body end cap 366 on the fastening device 370, e.g., on the fastening cord second end portion 370B. The cord retention means 378 can be any device, component, apparatus, system or mechanism suitable to fixedly retain the respective second connector body end caps 366 on the fastening device 370.

For example, in various embodiments, each retention means 378 can include a washer through which the respective fastening device 370, e.g., the fastening cord second end portion 370B, is inserted. Subsequently, a knot can be tied in the fastening cord second end portion 370B. Accordingly, the knots prevent the respective fastening cord second end portion 370B from pulling through respective washers, and the washers prevent the fastening cord second end portions 370B from pulling through the respective second connector body end cap aperture 374, thereby retaining the respective second connector body end cap 366 on the respective fastening cord second end portion 370B.

Alternatively, in various other exemplary embodiments, each retention means 378 can be a knot tied in the respective fastening cord second end portion 370B and sized to prevent the respective fastening cord second end portion 370B from pulling through respective second connector body end cap aperture 374, thereby retaining the respective second connector body end cap 366 on the respective fastening cord second end portion 370B.

In yet other exemplary embodiments, each retention means 378 can be a compression fitting fixedly attached to the fastening cord second end portions 370B, e.g., compressed onto the fastening cord second end portions 370B, such that the respective fastening cord second end portion 370B is prevented from pulling through respective second connector body end cap aperture 374, thereby retaining the respective second connector body end cap 366 on the respective fastening cord second end portion 370B.

Still further, each second body 354 can include one or more second connector body end cap retention means 382 structured and operable to fixedly retain each second connector body end cap 366 on the proximal end of each respective second body housing 362. Each second connector body end cap retention means 382 can be any device, component, apparatus, system or mechanism suitable to retain the respective second connector body end cap 366 on the proximal end of the respective second connector body housing 362.

For example, in various embodiments, each second connector body cap retention means 382 comprise a set screw that is threadable through one or more apertures in the side of the respective second connector body housings 362 to fixedly retain the respective second connector body end cap 366 on the proximal end of the respective second body housing 362. Alternatively, in various other exemplary embodiments, each second connector body end cap retention means 382 can comprise glue suitable to fixedly retain the respective second connector body end cap 366 on the proximal end of the respective second body housing 362. Or, in various other exemplary embodiments, each second connector body end cap retention means 382 can comprise a sonic weld, whereby the respective second connector body end cap 366 is sonically welded to the proximal end of the respective second body housing 362.

In yet other exemplary embodiments, each second connector body end cap retention means 382 can comprise a rivet, whereby the respective second connector body end cap 366 is riveted to the proximal end of the respective second body housing 362 to fixedly retain the respective second connector body end cap 366 on the proximal end of the respective body housings 362. Or, in still yet other exemplary embodiments, each second connector body end cap retention means 382 can comprise threads disposed on, or in, the respective second connector body end cap 366 and on, or in, the respective second body housing 362, whereby the respective end cap 366 is threadingly engaged with the respective body housing 362 to fixedly retain the respective end cap 366 on the proximal end of the respective body housing 362.

Thus, in such embodiments, as illustrated in FIGS. 12B and 12C, to connect, or attach, each intermediate safety coupling second connector 334 to the respective second connector fastening device 370, e.g., fastening cord second end portions, the respective fastening device second end portion 370B is inserted through the respective second connector body end cap aperture 374. Subsequently, the respective second retention means 378 is disposed, connected, attached or formed on the respective fastening device second end portion 370B to retain the respective second connector body end cap 366 on the fastening device second end portion 370B. Thereafter, each second connector body end cap 366 is fixedly retained on the proximal end of the respective second connector body housing 362, thereby connecting, or attaching, each respective second connector 334 to the respective fastening device second end portion 370B. Subsequently, or prior, the fastening device first end portion 370A of each fastening device 370 is connected to the respective shade intermediate portion 338 such that each intermediate safety coupling second connector 334 is connected to the respective shade intermediate portion 338.

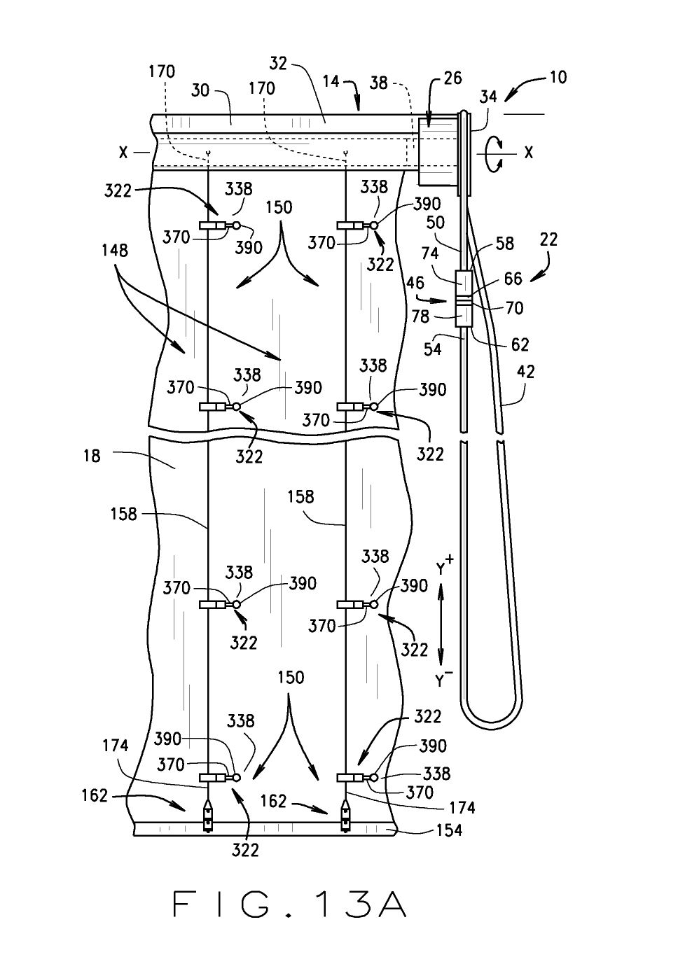

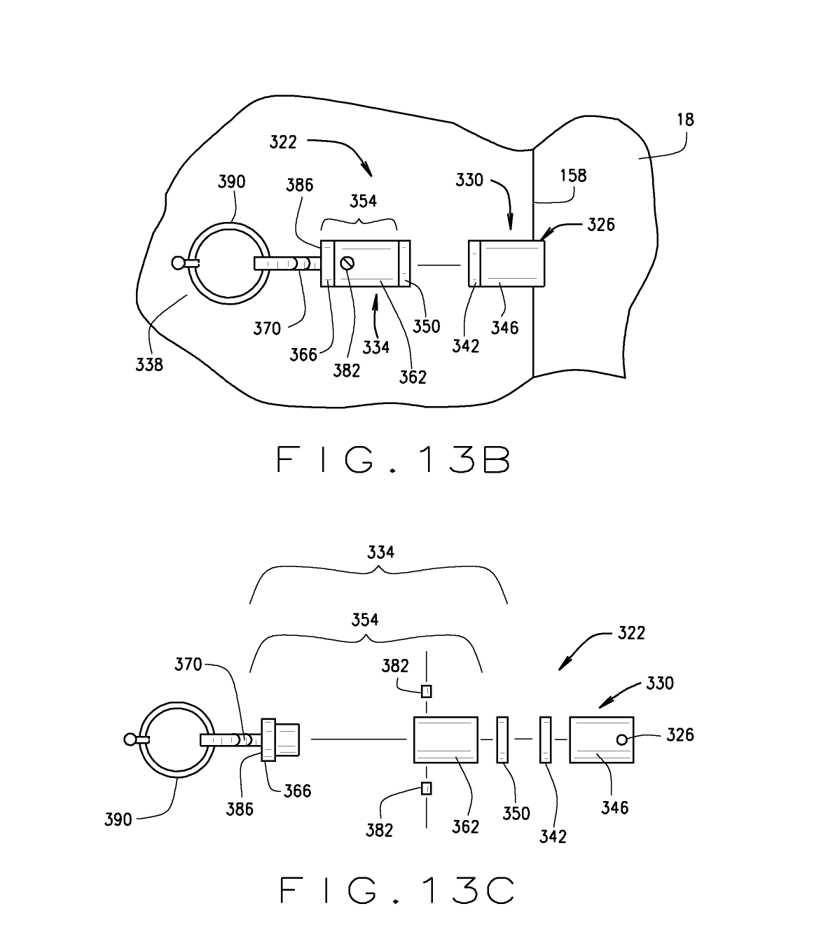

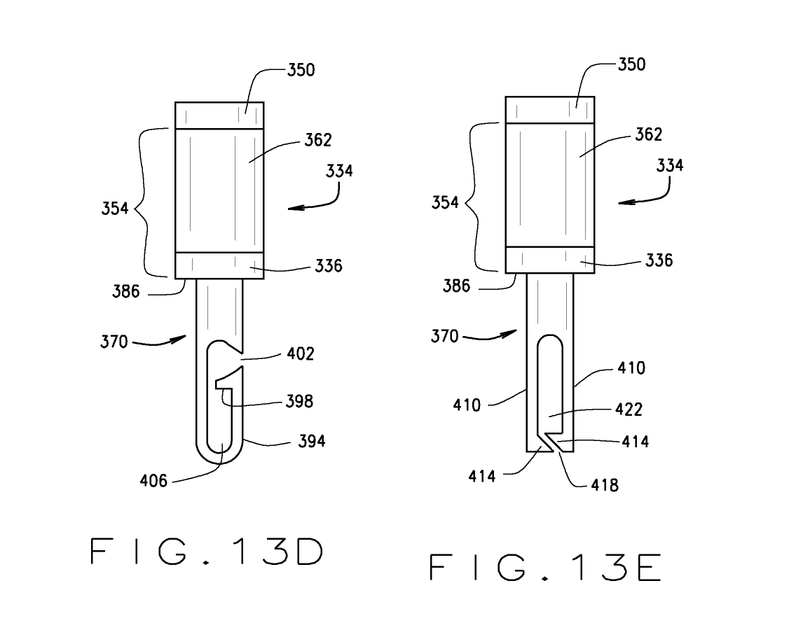

Referring now to FIGS. 13A, 13B and 13C, as described above, each intermediate safety coupling second connector 334 can be connected to the respective shade intermediate portion 338 in any manner suitable to fixedly retain the second connector 334 on respective shade intermediate portion 338. As also described above, in various embodiments, each intermediate safety coupling second connector 334 includes a fastening device 370 that is structured and operable to connect each respective second connector body end cap 366, and hence, the respective lift cord intermediate safety coupling second connector 334, to the respective shade intermediate portion 338. For example, in various implementations, each fastening device 370 can be a cord, string, wire, chain, tie, nylon connector, or any other device suitable for connecting each lift cord intermediate safety coupling second connector 334 to the respective shade intermediate portion 338. More particularly, in various implementations, as illustrated in FIGS. 13A, 13B, 13C, 13D and 13E, each fastening device 370 can comprise a nylon, plastic, or other material, clip that extends from a base 386 of the second connector body end cap 366 and is structured to be removably connectable to a lift cord intermediate attachment device 390 that is connected to a respective intermediate portion 338 of the respective shade 18.

In such implementations, each lift cord intermediate attachment device 390 can be any device suitable for removably connecting the respective clip 370, i.e., fastening device 370, thereto such that each respective intermediate safety coupling second connector 334 is removably connected to the shade 18 at the respective intermediate portion 338. And further, such that the respective lift cord 158 will be removably, or separably, connected to the respective shade intermediate portion 338 when the first and second connectors 330 and 334 are magnetically coupled together, as described above. Accordingly, when the intermediate safety coupling first and second connectors 330 and 334 of a respective safety lift cord assembly 148 are magnetically coupled, the respective intermediate safety coupling second connectors 334 are removably connected to the respective lift cord intermediate attachment devices 390, and the respective bottom safety coupling first and second connectors 178 and 182 are magnetically coupled, the respective safety lift cord assembly 148 is operable to pull on the shade bottom portion 154, while the respective lift cord 158 remains slidingly connected to the shade intermediate portions 338, via the magnetically connected intermediate safety couplings 322. Hence, the respective safety lift cord assembly 148 is operable to move at least a portion of the shade 18 between the first position and the second position.

For example, in various embodiments, each lift cord intermediate attachment device 390 can comprise a ring connected to the respective shade intermediate portions 154 such that the respective clip 370 of the respective second connector 334 can be removably clipped, i.e., connected, to the respective ring 390. Alternatively, each lift cord intermediate attachment device 390 can comprise a loop, tab, tag, grommet, post, hook or other suitable device, e.g., a thread, fabric, plastic, nylon, wire, metal, or other material loop, tab, tag, grommet, post, hook or other suitable device, having a portion thereof connected to the respective shade intermediate portions 338 and another portion thereof suitable for connection of the respective clip 370.

The clips 370 can have any shape, size or geometry that is structured to be removably connectable to the respective lift cord intermediate attachment devices 390. For example, as illustrated in FIG. 13D, in various embodiments, each clip 370 can have a hook and barb configuration wherein each clip 370 includes a hook 394 having a barb 398 formed at a distal end. In such embodiments, each lift cord intermediate attachment device 390, e.g., a ring, can be inserted into a mouth 402 of the respective clip 370, pulled past the barb 398 and disposed within a reservoir 406 of the hook 394. The barb 398 prevents each lift cord intermediate attachment device 390 from inadvertently disengaging from the respective clip 370 once the respective lift cord intermediate attachment device 390 is disposed within the respective reservoir 406. Or, as a further example, as illustrated in FIG. 13E, in various embodiments, each clip 370 can have a tang and barb configuration wherein each clip 370 includes a pair of opposing tangs 410 having overlapping barbs 414 formed at distal ends of the tangs 414. In such embodiments, each lift cord intermediate attachment device 390, e.g., rings, can be inserted into a mouth 418 of the respective clip 370, pushed past the overlapping barbs 414 and disposed within a gap 422 between the respective tangs 410. The overlapping barbs 414 prevent the respective lift cord intermediate attachment devices 390 from inadvertently disengaging from the respective clips 370 once the respective lift cord intermediate attachment devices 390 are disposed within the respective gaps 422.

As described above, in various embodiments, each intermediate safety coupling second connector body end cap 366, having the clip 370 extending therefrom, can be connected the second connector body housing 362, via any suitable intermediate safety coupling second cap retention means 382. Alternatively, in various embodiments, the second connector body housing 362, and the second connector body end cap 366, having the clip 370 extending therefrom, can be integrally formed as a single, unitary structure.

Accordingly, once each intermediate safety coupling second connector 334 is connected to the respective intermediate portion 338 of the shade 18, via the respective clips 370, each intermediate safety coupling 322 and hence, the respective safety lift cords 150 are operable to operate the shade 18 when the first and second connectors 330 and 334 of the respective lift cord intermediate safety couplings 322 are magnetically connected, as described above. Moreover, as described above, the first and second connectors 330 and 334 are magnetically connectable to each other, via the first and second magnets 342 and 350, with an amount of attractive force such that application of a longitudinal and/or lateral force to the respective lift cords 158 that is below the lift cord intermediate coupling threshold force will operate, i.e., raise and lower, the shade 18, as described above. However, application of a longitudinal and/or lateral force equal to or greater than the lift cord intermediate coupling threshold force will decouple, i.e., separate or pull apart, the first and second connectors 330 and 334, thereby separating the respective safety lift cord 150 from the shade 18.

For example, the predetermined lift cord intermediate coupling threshold force is selected to be sufficient to retain the magnetic coupling of each lift cord intermediate safety coupling 322 during raising and lowering of the shade 18, as described above. However, the lift cord intermediate coupling threshold force is additionally selected such that if a child were to have their arm, leg, or worse, begin to become entangled in any one or more of the lift cords 158, the resulting force on the respective safety lift cord(s) 150 would be greater than the predetermined lift cord intermediate coupling threshold force such that the first and second connectors 330 and 334 of the respective lift cord intermediate safety coupling(s) 322 would easily and readily decouple, separating the respective safety lift cord(s) 150 from the shade 18, thereby allowing the child's arm or leg to fall free from the severed lift cord 158.

It in envisioned that in the various embodiments, described above, wherein each fastening device 370 comprises a clip 370 extending from the base 386 of the second connector body end cap 366, each intermediate safety coupling 162 can be a retrofittable intermediate safety coupling 322 that can be installed on existing shades 18 that were not manufactured with the safety lift cord assemblies 148. More specifically, in such embodiments, the intermediate safety couplings 322 can be added to the lift cord assemblies 148, along with the retrofittable bottom safety couplings 162 described above, to modify the respective shade 18 to include a plurality of safety lift cord assemblies 148.

In such retrofit instances, the respective shade 18 will typically include a plurality of lift cords that are connected at an upper end to a shade movement barrel 30 and connected at lower ends to bottom portion of the respective shade, via a lift cord bottom attachment device 286, such as rings 286 exemplarily shown in FIGS. 11A, 11B and 11C. Additionally, each lift cord with be threaded through a center aperture of each of a plurality of the guide rings that are connected to the shade 18 in a longitudinally aligned arrangement between where the respective bottom safety coupling second connector 182 is connected to the shade bottom portion 154 and where the respective lift cord upper end 170 is connected to the shade movement barrel 30, similar to what is exemplarily illustrated in FIG. 6. In order to modify the respective shade 18 to include a plurality of retrofit safety lift cord assemblies 148, i.e., the retrofit bottom safety couplings 162 and the retrofit intermediate safety couplings 322, the lower end of each lift cord is detached from the respective lift cord bottom attachment device 286, whereby the detached lower ends of the lift cords become the lift cord lower ends 174 described above.

Thereafter, each lift cord lower end 174 can be threaded through the apertures 326 of a suitable number of intermediate safety coupling first connectors 330 and subsequently connected to a respective bottom safety coupling first connector 178, as described above. Additionally, each respective intermediate safety coupling second connector 334 can be connected, or clipped, to a respective one of the lift cord intermediate attachment devices 390, e.g., rings similar to the guide rings exemplarily illustrated in FIG. 6. Still further, each respective bottom safety coupling second connector 182 can be connected, or clipped, to the lift cord bottom attachment device 286, via the respective bottom coupling clips 226, as described above. Subsequently, the intermediate safety coupling first and second connectors 330 and 334, the bottom safety coupling first and second connectors 178 and 182, can be magnetically coupled, via the respective magnets 342 and 350, and 186 and 190, as described above, to thereby retrofit the shade 18 with the retrofit safety lift cord assemblies 148 described herein with regard to FIGS. 13A, 13B, 13C, 13D and 13E.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A safety coupling for a lift cord of a window covering system, said safety coupling comprising:
a first connector including a lift cord aperture extending through a proximal end of the first connector, the lift cord aperture structured to have the lift cord of a shade of the window covering system extended therethrough, an upper end of the lift cord connectable to a shade movement barrel of the window covering system and a lower end of the lift cord connectable to a bottom portion of a shade of the window covering system to operatively connect the shade movement barrel to the shade bottom portion such that operation of the shade movement barrel will apply a longitudinal force to the lift cord that will move at least a portion of the shade between a first position and a second position; and
a second connector having a proximal end that is removably connectable to a first end of a lift cord intermediate attachment device of the window covering system that is connected at an opposing second end to the shade at a single point of an intermediate portion of the shade, the second connector additionally having an opposing distal end that is magnetically connectable to a distal end of the first connector to slidingly connect the lift cord to the single point of the shade intermediate portion and restrict lateral movement of the lift cord during movement of the at least a portion of the shade between the first position and the second position, the first and second connectors magnetically connectable with an amount of attractive force such that:
when at least one of a longitudinal and a lateral force below a predetermined threshold force is applied to at least one of the first and second connectors, the first and second connectors will remain connected such that the lift cord remains slidingly connected to the single point of the shade intermediate portion and lateral movement of the lift cord will be restricted as the at least a portion of the shade is moved between the first position and the second position, and
when at least one of a longitudinal and a lateral force that is one of greater than and equal to the predetermined threshold force is applied to at least one of the first and second connectors, the first and second connectors will decouple disconnecting the lift cord from the single point of the shade intermediate portion.

2. The safety coupling of claim 1, wherein:
the first connector comprises a body having the lift cord aperture laterally extending through a proximal end; and
the second connector comprises a body connectable to a fastening device structured and operable to connect the second connector body to the first end of the lift cord intermediate attachment device.

3. The safety coupling of claim 2, wherein the second connector body comprises a proximal end having a fastening device aperture through which an end of the fastening device can be inserted, and a fastening device retention means structured and operable to fixedly retain the second connector body on the end of the fastening device.

4. The safety coupling of claim 3, wherein the second connector fastening device comprises a clip extending from a base of the second connector, the clip structured and operable to removably connect to the lift cord intermediate attachment device.

5. A safety lift cord assembly for a window covering system, said safety lift cord assembly comprising:
a lift cord having an upper end connectable to a shade movement barrel of the window covering system and a lower end connectable to a bottom portion of a shade of the window covering system to operatively connect the shade movement barrel to the shade bottom portion such that operation of the shade movement barrel will apply a longitudinal force to the lift cord that will move at least a portion of the shade between a first position and a second position; and
a lift cord intermediate safety coupling structured and operable to slidingly connect the lift cord to a single point of an intermediate portion of the shade and to restrict lateral movement of the lift cord during movement of the at least a portion of the shade between the first position and the second position, the lift cord intermediate safety coupling comprising:
a first connector including a lift cord aperture extending through a proximal end of the first connector, the lift cord aperture structured to have the lift cord extended therethrough; and
a second connector having a proximal end that is removably connectable to a first end of a lift cord intermediate attachment device of the window covering system that is connected at an opposing second end to the single point of the intermediate portion of the shade, the second connector additionally having an opposing distal end that is magnetically connectable to a distal end of the first connector to slidingly connect the lift cord to the shade intermediate portion and restrict lateral movement of the lift cord during movement of the at least a portion of the shade between the first position and the second position, the first and second connectors magnetically connectable with an amount of attractive force such that:
when at least one of a longitudinal and a lateral force below a predetermined threshold force is applied to at least one of the first and second connectors, the first and second connectors will remain connected such that the lift cord remains slidingly connected to the single point of the shade intermediate portion and lateral movement of the lift cord will be restricted as the at least a portion of the shade is moved between the first position and the second position, and
when at least one a longitudinal and a lateral force that is one of greater than and equal to the predetermined threshold force is applied to at least one of the first and second connectors, the first and second connectors will decouple disconnecting the lift cord from the single point of the shade intermediate portion.

6. The assembly of claim 5, wherein:
the first connector comprises a body having the lift cord aperture laterally extending through a proximal end; and
the second connector comprises a body connectable to a fastening device structured and operable to removably connect the second connector body to the first end of the lift cord intermediate attachment device.

7. The assembly of claim 6, wherein the second connector body comprises a proximal end having a fastening device aperture through which an end of the fastening device can be inserted, and a fastening device retention means structured and operable to fixedly retain the second connector body on the end of the fastening device.

8. The assembly of claim 7, wherein the second connector fastening device comprises a clip extending from a base of the second connector, the clip structured and operable to removably connect to the lift cord intermediate attachment device.

9. A window covering system, said system comprising:
a head unit mountable to structure forming a window opening, the head unit including a clutch mechanism connected to an end of a shade movement barrel such that operation of the clutch mechanism operates the shade movement barrel;
a shade having a top portion connected to the head unit; and
a plurality of safety lift cord assemblies structured to operatively connect a bottom portion of the shade to the shade movement barrel to move at least a portion of the shade between a first position and a second position when the clutch mechanism is operated, each safety lift cord assembly comprising:
a lift cord having an upper end connectable to the shade movement barrel and a lower end connectable to the shade bottom portion to operatively connect the shade movement barrel to the shade bottom portion such that operation of the shade movement barrel will apply a longitudinal force to the lift cord that will move at least a portion of the shade between a first position and a second position; and
a plurality of lift cord intermediate safety couplings, each intermediate safety coupling structured and operable to slidingly connect the lift cord to a respecting single point of a respective one of plurality of intermediate portions of the shade and to restrict lateral movement of the lift cord during movement of the at least a portion of the shade between the first position and the second position, each lift cord intermediate safety coupling comprising:
a first connector including a lift cord aperture extending through a proximal end of the first connector, the lift cord aperture structured to have the lift cord extended therethrough; and
a second connector having a proximal end that is removably connectable to a first end of a lift cord intermediate attachment device of the window covering system that is connected at an opposing second end to the respective single point of the respective intermediate portion of the shade, the second connector additionally having an opposing distal end that is magnetically connectable to a distal end of the first connector to slidingly connect the lift cord to the respective single point of the respective shade intermediate portion and restrict lateral movement of the lift cord during movement of the at least a portion of the shade between the first position and the second position, the first and second connector of each intermediate safety coupling magnetically connectable with an amount of attractive force such that:
when at least one of a longitudinal an a lateral force below a predetermined threshold force is applied to at least one of the first and second connector, the first and second connectors will remain connected such that the lift cord remains slidingly connected to the respective single point of the respective shade intermediate portion and lateral movement of the lift cord will be restricted as the at least a portion of the shade is moved between the first position and the second position, and
when at least one of a longitudinal and a lateral force that is one greater than and equal to the predetermined threshold force is applied to at least one of the first and second connector, the first and second connectors will decouple disconnecting the lift cord from the respective single point of the respective shade intermediate portion.

10. The system of claim 9, wherein:
each first connector comprises a body having the lift cord aperture laterally extending through a proximal end; and
each second connector comprises a body connectable to a fastening device structured and operable to connect the second connector body to the first end of the lift cord intermediate attachment device.

11. The system of claim 10, wherein each second connector body comprises a proximal end having a fastening device aperture through which an end of the fastening device can be inserted, and a fastening device retention means structured and operable to fixedly retain the second connector body on the end of the fastening device.

12. The system of claim 11, wherein each second connector fastening device comprises a clip extending from a base of the second connector, the clip structured and operable to removably connect to the lift cord intermediate attachment device.
